(19) United States
(12) Patent Application Publication
(10) Pub. No.: US 2025/0203572 A1
(43) Pub. Date: Jun. 19, 2025

(54) SIDELINK POSITIONING REFERENCE UNIT MANAGEMENT

(71) Applicant: Lenovo (Singapore) Pte. Limited, Singapore (SG)

(72) Inventors: Robin Rajan Thomas, Frankfurt (DE); Karthikeyan Ganesan, Kronberg Im Taunus (DE); Abir Ben Hadj Fredj, Wiesbaden (DE)

(73) Assignee: Lenovo (Singapore) Pte. Limited, Singapore (SG)

(21) Appl. No.: 18/848,793

(22) PCT Filed: Mar. 7, 2023
(86) PCT No.: PCT/IB2023/052164

§ 371 Date: Sep. 19, 2024

Related U.S. Application Data
(60) Provisional application No. 63/322,026, filed on Mar. 21, 2022.
(60) Provisional application No. 63/321,898, filed on Mar. 21, 2022.

(51) Int. Cl. H04W 64/00; H04W 8/24; H04W 92/18

(52) U.S. Cl. CPC H04W 64/006; H04W 8/24; H04W 92/18

(57) ABSTRACT

Various aspects of the present disclosure relate to a sidelink (SL) positioning reference unit (PRU) that receives a SL PRU configuration based on different functionalities, such as the correction of timing drifts and angular errors. The SL PRU collects one or more SL positioning reference measurements in accordance with the SL PRU configuration and can transmit the collected measurements to another entity, such as a configuration entity or a positioning calculation entity. Measurement error correction information can then be generated from the collected measurements.

### RELATED APPLICATIONS

This application claims priority to U.S. Patent Application Ser. No. 63/322,026 filed Mar. 21, 2022 entitled “Sidelink Positioning Reference Unit Management,” the disclosure of which is incorporated by reference herein in its entirety. This application also claims priority to U.S. Patent Application Ser. No. 63/321,898 filed Mar. 21, 2022 entitled “Sidelink Anchor Device Management,” the disclosure of which is incorporated by reference herein in its entirety.

### TECHNICAL FIELD

The present disclosure relates to wireless communications, and more specifically to managing or using a sidelink (SL) positioning reference unit (PRU).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Various applications that may run on a UE or on a network entity may desire to know the location of the UE. However, as the UEs may be mobile, the locations of the UEs may vary over time. Accordingly, various techniques may be used to facilitate determining the location or position of a UE.

### SUMMARY

The present disclosure relates to methods, apparatuses, and systems that support sidelink positioning reference unit management. SL PRUs, also referred to as SL reference devices, with known locations in time can serve as positioning nodes and assist in correction of sidelink timing errors. A SL PRU configuration is described based on different functionalities, such as the correction of timing drifts and angular errors. The SL PRU configuration is provided to a SL PRU, which collects one or more SL positioning reference measurements in accordance with the SL PRU configuration and transmits the collected measurements to another entity, such as a configuration entity or a positioning calculation entity. Measurement error correction information can then be generated from the collected measurements. By utilizing the described techniques, a mechanism to identify, select and configure SL PRUs for absolute and relative location estimation that accounts for SL timing errors is made available.

Some implementations of the method and apparatuses described herein may include wireless communication at a device (e.g., a SL PRU), and the device receives, from a configuration entity, a measurement configuration to perform sidelink positioning reference measurements; collects one or more sidelink positioning reference measurements; and transmits, to the configuration entity, the one or more sidelink positioning reference measurements and a known location of the apparatus.

In some implementations of the method and apparatuses described herein, the one or more sidelink positioning reference measurements include at least one of a timing-based reference measurement or an angular-based reference measurement. Additionally or alternatively, the one or more sidelink positioning reference measurements include at least one of a sidelink reference signal time difference (SL-RSTD) reference measurement, a sidelink (SL) UE receive transmit (Rx-Tx) time difference reference measurement, a SL time-of-flight (ToF) reference measurement, a time-of-arrival (ToA) reference measurement, a SL-angle-of-arrival measurement, a SL time difference of arrival (TDoA) reference measurement, a SL round trip time (RTT) reference measurement, or a SL angle of arrival (AoA) reference measurement. Additionally or alternatively, the known location of the apparatus includes one or more of 2D or 3D latitude and longitude information, height or altitude information, a velocity estimate, an antenna and panel related location information and reference points, or an uncertainty value or a confidence interval associated with the known location. Additionally or alternatively, the configuration entity comprises a UE and the device further: receives, from the UE, a request for the one or more sidelink positioning reference measurements and the known location of the apparatus; and transmits, to the UE in response to the request, the one or more sidelink positioning reference measurements and a known location of the apparatus. Additionally or alternatively, the configuration entity comprises a network entity, and the device further: receives, from the network entity, a request for the one or more sidelink positioning reference measurements and the known location of the apparatus; and transmits, to the network entity in response to the request, the one or more sidelink positioning reference measurements and a known location of the apparatus. Additionally or alternatively, the device comprises a UE, and the device further operates in at least one of a UE-based UE-configured positioning mode, a UE-based network-configured positioning mode, a UE-assisted UE-configured positioning mode, or a UE-assisted network-configured positioning mode. Additionally or alternatively, the device further collects the one or more sidelink positioning reference measurements in a frequency range 1 (FR1) band or a frequency range 2 (FR2) band. Additionally or alternatively, the device further: collects one or more new radio (NR) Uu interface positioning reference measurements; and transmits, to a base station, the one or more NR Uu positioning reference measurements and the known location of the apparatus. Additionally or alternatively, the apparatus includes an apparatus identifier (ID) that is at least one of a layer one ID (L1-ID) derived from a layer two ID (L2-ID), a self-generated ID, or an application ID generated by a sidelink positioning application of the apparatus, and the apparatus further: transmits, to the configuration entity, the apparatus ID with the one or more sidelink positioning reference measurements and the known location of the apparatus. Additionally or alternatively, the device further: receives, from a UE, a request for capability information regarding the apparatus acting as a sidelink positioning reference unit; and transmits, to the UE in response to the request, capability information regarding the apparatus acting as a sidelink positioning reference unit. Additionally or alternatively, the device further: receives, from a network entity, a request for capability information regarding the apparatus acting as a sidelink positioning reference unit; and transmits, to the network entity in response to the request, capability information regarding the apparatus acting as a sidelink positioning reference unit. Additionally or alternatively, the device further: dynamically updates the known location and antenna orientation information of the device, where the updated known location and antenna orientation information is based at least in part on delta locations compared to one or more previously reported locations.

Some implementations of the method and apparatuses described herein may include wireless communication at a device (e.g., a configuration entity), and the device receives, from a PRU, one or more sidelink positioning reference measurements and a known location of the PRU; generates measurement error correction information based at least in part on the one or more sidelink positioning reference measurements; and transmits, to a positioning calculation entity, the measurement error correction information.

In some implementations of the method and apparatuses described herein, the device further: generates the measurement error correction information by determining a calibration of timing-based and angular-based measurement errors based at least in part on the on the one or more sidelink positioning reference measurements; and transmits, to the PRU as the measurement error correction information, the timing-based and angular-based measurement error correction information. Additionally or alternatively, the measurement error correction information includes at least one of pseudo-range errors, synchronization timing errors, reference signal time difference (RSTD) reference measurements, angle of arrival (AOA) calibration errors, or time validity duration of the measurement error correction information. Additionally or alternatively, the device further: transmits, to the PRU, a measurement configuration for the PRU to perform sidelink positioning reference measurements using the one or more sidelink positioning reference measurements; and receives, in response to the measurement configuration, the one or more sidelink positioning reference measurements and the known location of the PRU. Additionally or alternatively, the device is the positioning calculation entity. Additionally or alternatively, the one or more sidelink positioning reference measurements include at least one of a timing-based reference measurement or an angular-based reference measurement. Additionally or alternatively, the one or more sidelink positioning reference measurements include at least one of a SL-RSTD reference measurement, a SL UE Rx-Tx time difference reference measurement, a SL ToF reference measurement, a ToA reference measurement, a SL-angle-of-arrival measurement, a SL TDoA reference measurement, a SL RTT reference measurement, or a SL AoA reference measurement. Additionally or alternatively, the known location of the PRU includes one or more of 2D or 3D latitude and longitude information, height or altitude information, a velocity estimate, an antenna and panel related location information and reference points, or an uncertainty value or a confidence interval associated with the known location. Additionally or alternatively, the device comprises a UE, and the device further: transmits, to the PRU, a request for the one or more sidelink positioning reference measurements and the known location of the PRU; and receives, from the PRU in response to the request, the one or more sidelink positioning reference measurements and a known location of the PRU. Additionally or alternatively, the device comprises a network entity, and the device further: transmits, to the PRU, a request for the one or more sidelink positioning reference measurements and the known location of the PRU; and receives, from the PRU in response to the request, the one or more sidelink positioning reference measurements and a known location of the PRU. Additionally or alternatively, the PRU includes a PRU ID that is at least one of a L1-ID derived from a L2-ID, a self-generated ID, or an application ID generated by a sidelink positioning application of the PRU, and the device further: receives, from the PRU, the PRU ID with the one or more sidelink positioning reference measurements and the known location of the PRU. Additionally or alternatively, the device further: transmits, to the PRU, a request for capability information regarding the PRU acting as a sidelink positioning reference unit; and receives, from the PRU in response to the request, capability information regarding the PRU acting as a sidelink positioning reference unit.

### BRIEF DESCRIPTION OF THE DRAWINGS

Various aspects of the present disclosure for sidelink positioning reference unit management are described with reference to the following Figures. The same numbers may be used throughout to reference like features and components shown in the Figures.

FIG. 1 illustrates an example of a wireless communications system that supports sidelink positioning reference unit management in accordance with aspects of the present disclosure.

FIG. 2 illustrates an example of absolute and relative positioning scenarios as related to sidelink positioning reference unit management in accordance with aspects of the present disclosure.

FIG. 3 illustrates an example of a multi-cell RTT procedure as related to sidelink positioning reference unit management in accordance with aspects of the present disclosure.

FIG. 4 illustrates an example of a system for existing relative range estimation as related to sidelink positioning reference unit management in accordance with aspects of the present disclosure.

FIG. 5 illustrates an example of a system of NR beam-based positioning as related to sidelink positioning reference unit management in accordance with aspects of the present disclosure.

FIG. 6 illustrates an example of a LTE positioning protocol (LPP) request location information (RequestLocationInformation) message as related to sidelink positioning reference unit management, as described herein.

FIG. 7 illustrates an example of a LPP information (ProvideLocationInformation) message as related to sidelink positioning reference unit management, as described herein.

FIG. 8 illustrates an example of SL timing error corrections using SL PRU as related to sidelink positioning reference unit management.

FIG. 9 illustrates an example of a type of request and response signaling exchange for reference measurements between a configuration entity or positioning calculation entity and a SL PRU as related to sidelink positioning reference unit management.

FIG. 10 illustrates an example of another type of request and response signaling exchange for reference measurements between a configuration entity or positioning calculation entity and a SL PRU as related to sidelink positioning reference unit management.

FIG. 11 illustrates an example of a type of capability exchange for a SL positioning reference unit as related to sidelink positioning reference unit management.

FIG. 12 illustrates an example of another type of capability exchange for a SL positioning reference unit as related to sidelink positioning reference unit management.

FIG. 13 illustrates an example of sidelink anchor devices identification with respect to a target device, which supports sidelink anchor device management in accordance with aspects of the present disclosure.

FIG. 14 illustrates an example of an implementation for signaling sidelink real time difference (RTD) information, which supports sidelink anchor device management in accordance with aspects of the present disclosure.

FIG. 15 illustrates an example of anchor device capability exchange that supports sidelink anchor device management in accordance with aspects of the present disclosure.

FIG. 16 illustrates an example of anchor device capability exchange that supports sidelink anchor device management in accordance with aspects of the present disclosure.

FIG. 17 illustrates an example of a block diagram of a device that supports sidelink positioning reference unit management in accordance with aspects of the present disclosure.

FIG. 18 illustrates another example of a block diagram of a device that supports sidelink positioning reference unit management in accordance with aspects of the present disclosure.

FIGS. 19, 20, 21, 22, 23, and 24 illustrate flowcharts of methods that supports sidelink positioning reference unit management in accordance with aspects of the present disclosure.

### DETAILED DESCRIPTION

Implementations of sidelink positioning reference unit management are described, such as related to SL PRUs, also referred to as SL reference devices, with known locations in time that serve as positioning nodes and assist in correction of sidelink timing errors. A SL PRU configuration is described based on different functionalities, such as the correction of timing drifts and angular errors.

The SL PRU configuration is provided to a SL PRU, which configures the SL PRU to collect SL reference positioning measurements and the known location information. The SL PRU proceeds to collect one or more SL positioning reference measurements and transmit the collected measurements as well as the known location to the configuration entity or positioning calculation entity. Techniques for performing timing and receiver error correction using a SL positioning reference unit are also described. These techniques allow the configuration entity or positioning calculation entity to derive the SL correction information to perform the error correction.

Techniques to manage multiple SL PRUs including reference anchor devices using identifiers, such as layer 1 and layer 2 identifiers, are also described. The use of SL PRU IDs allows the mobility of SL PRUs to be accounted for and a new SL PRU to be selected when appropriate. Techniques to support SL PRU capability exchange between a SL PRU and a configuration entity are also described. This provides an entity, such as a configuration entity, with the ability to account for various different SL PRU functionality in selecting a SL PRU.

Due to the distributed nature of SL, it can be expected that the anchor and reference devices may comprise of varying degrees of mobility including low, medium and high degree of mobility. Furthermore, in the case of SL positioning the timely and accurate measurements are essential to obtain high absolute and relative positioning accuracy. Several issues make SL positioning different from traditional positioning, including moving and distributed nodes, varying mobility of nodes, availability of anchor and non-anchor nodes, high probability of transmitter and receiver clock errors and delays between baseband and radio frequency (RF), and so forth. By utilizing the described techniques, a mechanism to identify, select and configure SL PRUs for absolute and relative location estimation that accounts for these issues is made available.

Aspects of the present disclosure are described in the context of a wireless communications system. Aspects of the present disclosure are further illustrated and described with reference to device diagrams and flowcharts that relate to sidelink positioning reference unit management.

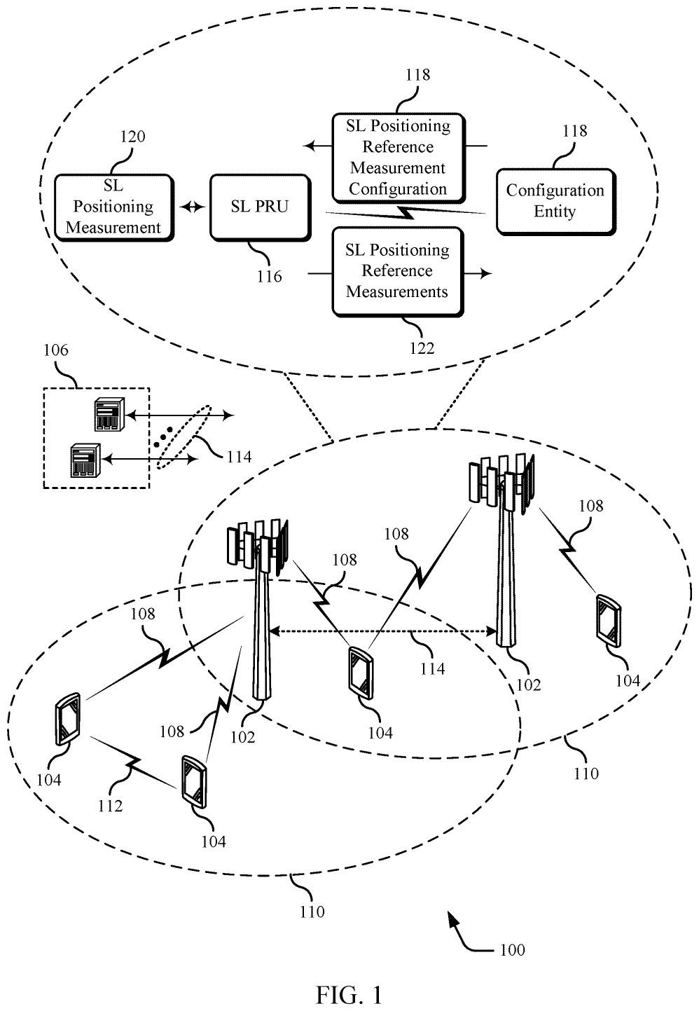

FIG. 1 illustrates an example of a wireless communications system 100 that supports sidelink positioning reference unit management in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations one or more SL PRUs 116 and configuration entities 118 are operable to implement various aspects of sidelink positioning reference unit management, as described herein. For instance, the SL PRU 116 receives a SL positioning reference management configuration, performs SL positioning measuring 120 to collect SL positioning reference measurements 122 that are transmitted to the configuring entity or a position calculation entity. The SL PRU 116 refers to any device that can perform or collect SL positioning reference measurements, such as a UE 104 or a roadside unit. The configuration entity 118 refers to any device that can transmit a measurement configuration to perform or collect SL positioning measurement measurements, such as (or position calculation entity) a UE 104, a roadside unit, a base station 102, or a location server. The position calculation entity refers to any device that can transmit a measurement configuration to perform or collect SL positioning measurement measurements, such as) a UE 104, a base station 102, or a location server.

Additionally or alternatively, one or more of a device (e.g., implemented as a configuration entity) and a sidelink anchor device are operable to implement various aspects of sidelink anchor device management, as described herein. Either of the device (e.g., the configuration entity) and/or the sidelink anchor device may be implemented in the wireless communications system 100 as a UE 104, an anchor UE, a base station 102, a gNB, a roadside unit, a target UE, a reference UE, a location server, an unmanned or uncrewed ariel vehicle (UAV) (e.g., a drone), and/or as any other type of network devices or entities performing procedures for sidelink anchor device management. For instance, the device (e.g., the configuration entity) can communicate or transmit a sidelink positioning capability request to one or more potential sidelink anchor devices via a sidelink communication link. The sidelink anchor devices receive the sidelink positioning capability request from the device and can respond with anchor device capability information and a location of each of the respective sidelink anchor devices. Accordingly, the device (e.g., the configuration entity) can then select at least one of the potential sidelink anchor devices as an anchor device based on the anchor device capability information and the location of the sidelink devices. The device (e.g., the configuration entity) can then transmit a sidelink positioning reference signal transmission configuration to the selected sidelink anchor device, establishing a sidelink positioning session with a target device.

NR positioning based on NR Uu signals and standalone (SA) architecture (e.g., beam-based transmissions) was first specified in Rel-16. The target use cases also included commercial and regulatory (emergency services) scenarios as in Rel-15. Table T1 shows the performance requirements for NR positioning (e.g., in 3rd Generation Partnership Project (3GPP) technical report (TR) 38.855).

TABLE T1

| Positioning | | |
|---|---|---|
| Error | Indoor | Outdoor |
| Horizontal | <3 m for 80% of UEs | <10 m for 80% of UEs |
| Positioning | | |
| Vertical | <3 m for 80% of UEs | <3 m for 80% of UEs |
| Positioning | | |

Current 3GPP Rel-17 Positioning has defined the positioning performance requirements for commercial and industrial internet of things (IIOT) use cases as shown in Table T2 (e.g., as discussed in 3GPP TR 38.857).

TABLE T2

| Positioning Error | Commercial | IIoT |
|---|---|---|
| Horizontal | (<1 m) for 90% of UEs | (<0.2 m) for 90% of UEs; |
| Positioning | | |
| Vertical | (<3 m) for 90% of UEs | (<1 m) for 90% of UEs |
| Positioning | | |
| Physical layer | (<10 ms) | (<10 ms) |
| latency | | |
| for position | | |
| estimation of | | |
| UE | | |
| End-to-End | (<100 ms) | (<100 ms, in the order |
| Latency for | | of 10 ms is desired) |
| position | | |
| estimation of | | |
| UE | | |

The supported positioning techniques (release 16) are listed in Table T2, and separate positioning techniques can be currently configured and performed based on the requirements of the location management function (LMF) and UE capabilities. The transmission of Positioning Reference Signals (PRS) enable the UE to perform UE positioning-related measurements to enable the computation of a UE's location estimate and are configured per transmission reception point (TRP), where a TRP may transmit one or more beams. Various RAT-dependent positioning techniques (also referred to as positioning methods, or positioning procedures) are supported for a UE, for UE-assisted, LMF-based, and/or for next generation radio access network (NG-RAN) node assisted. The RAT-dependent positioning techniques that are supported include DL-TDOA, downlink-angle of departure (DL-AoD), multi-round trip time (multi-RTT), new radio enhanced cell-ID (NR E-CID); uplink-time difference of arrival (UL-TDOA); and uplink-angle of arrival (UL-AoA).

TABLE T3
Supported Rel-16 UE positioning methods

| | | UE- | NG- | |
|---|---|---|---|---|
| | | assisted, | RAN | |
| | UE- | LMF- | node | |
| Method | based | based | assisted | SUPL |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE 1}:
This includes terrestrial beacon system (TBS) positioning based on PRS signals.
^{NOTE 2}:
In this version of the specification only observed time difference of arrival (OTDOA) based on LTE signals is supported.
^{NOTE 3}:
Void.
^{NOTE 4}:
This includes Cell-ID for NR method.
^{NOTE 5}:
In this version of the specification only for TBS positioning based on MBS signals.
^{NOTE 6}:
Void

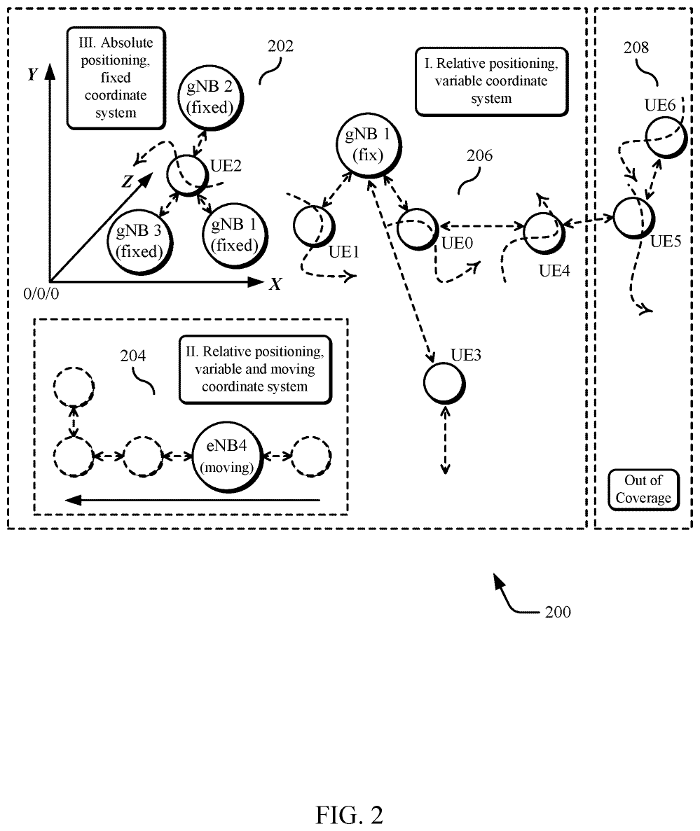

FIG. 2 illustrates an example 200 of absolute and relative positioning scenarios as related to sidelink positioning reference unit management in accordance with aspects of the present disclosure. The network devices described with reference to example 200 may use and/or be implemented with the wireless communications system 100 and include UEs 104 and base stations 102 (e.g., eNB, gNB). The example 200 is an overview of absolute and relative positioning scenarios as defined in the architectural (stage 1) specifications using three different co-ordinate systems, including (III) a conventional absolute positioning, fixed coordinate system at 202; (II) a relative positioning, variable and moving coordinate system at 204; and (I) a relative positioning, variable coordinate system at 206. Notably, the relative positioning, variable coordinate system at 206 is based on relative device positions in a variable coordinate system, where the reference may be always changing with the multiple nodes that are moving in different directions. The example 200 also includes a scenario 208 for an out of coverage area in which UEs need to determine relative position with respect to each other.

With reference to RAT-dependent positioning techniques, the DL-TDOA positioning technique utilizes at least three network nodes for positioning based on triangulation. The DL-TDOA positioning method makes use of the downlink reference signal time difference (RSTD) (and optionally DL PRS RSRP) of downlink signals received from multiple transmission points (TPs) at the UE. The UE measures the downlink RSTD (and optionally DL PRS RSRP) of the received signals using assistance data received from the positioning server (also referred to herein as the location server), and the resulting measurements are used along with other configuration information to locate the UE in relation to the neighboring TPs.

The DL-AoD positioning technique makes use of the measured downlink PRS reference signal received power (RSRP) (DL PRS RSRP) of downlink signals received from multiple TPs at the UE. The UE measures the DL PRS RSRP of the received signals using assistance data received from the positioning server (also referred to herein as the location server), and the resulting measurements are used along with other configuration information to locate the UE in relation to the neighboring TPs.

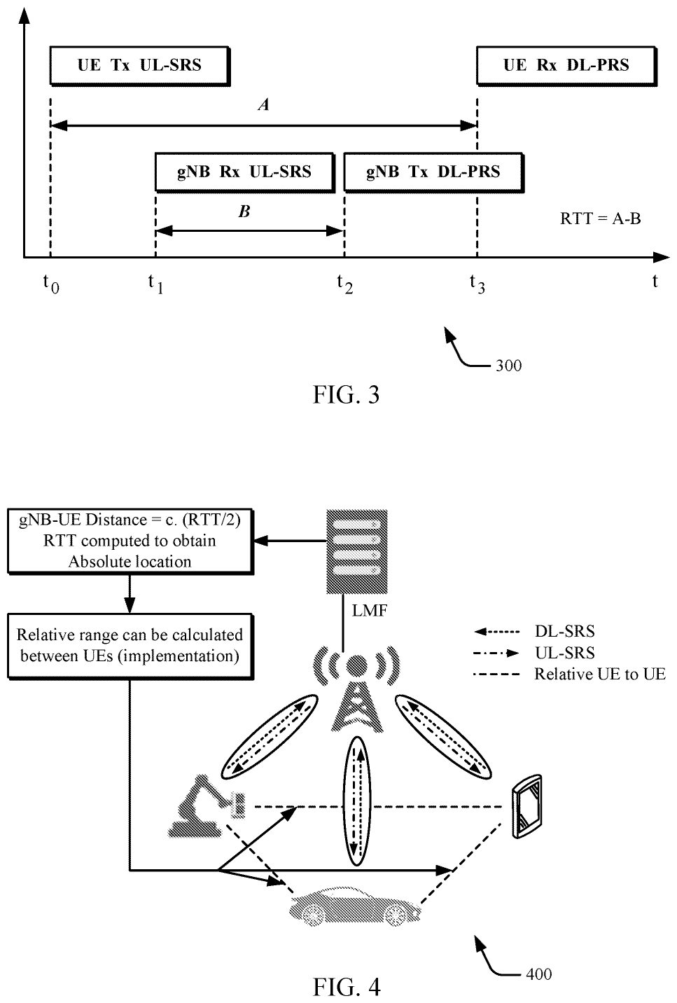

FIG. 3 illustrates an example 300 of a multi-cell RTT procedure as related to sidelink positioning reference unit management in accordance with aspects of the present disclosure. The multi-RTT positioning technique makes use of the UE receiver (Rx)-transmitter (Tx) measurements and DL PRS RSRP of downlink signals received from multiple TRPs, as measured by the UE and the measured gNB Rx-Tx measurements and uplink sounding reference signal (SRS) RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. The multi-RTT is only supported for UE-assisted and NG-RAN assisted positioning techniques as noted in Table T3.

FIG. 4 illustrates an example of a system 400 for existing relative range estimation as related to sidelink positioning reference unit management in accordance with aspects of the present disclosure. The system 400 illustrates the relative range estimation using the existing single gNB RTT positioning framework. The location server (LMF) can configure measurements to the different UEs, and then the target UEs can report their measurements in a transparent way to the location server. The location server can compute the absolute location, but in order to get the relative distance between two of the UEs, it would need prior information, such as the locations of the target UEs.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the radio resource control (RRC) protocol, the UE may not make additional measurements for the sole purpose of positioning (i.e., the positioning procedures do not supply a measurement configuration or measurement control message, and the UE reports the measurements that it has available rather than being required to take additional measurement actions).

The uplink time difference of arrival (UL-TDOA) positioning technique makes use of the UL-TDOA (and optionally UL SRS-RSRP) at multiple reception points (RPs) of uplink signals transmitted from UE. The RPs measure the UL-TDOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA and zenith-AoA of the received signals using assistance data received from the positioning server (also referred to herein as the location server), and the resulting measurements are used along with other configuration information to estimate the location of the UE.

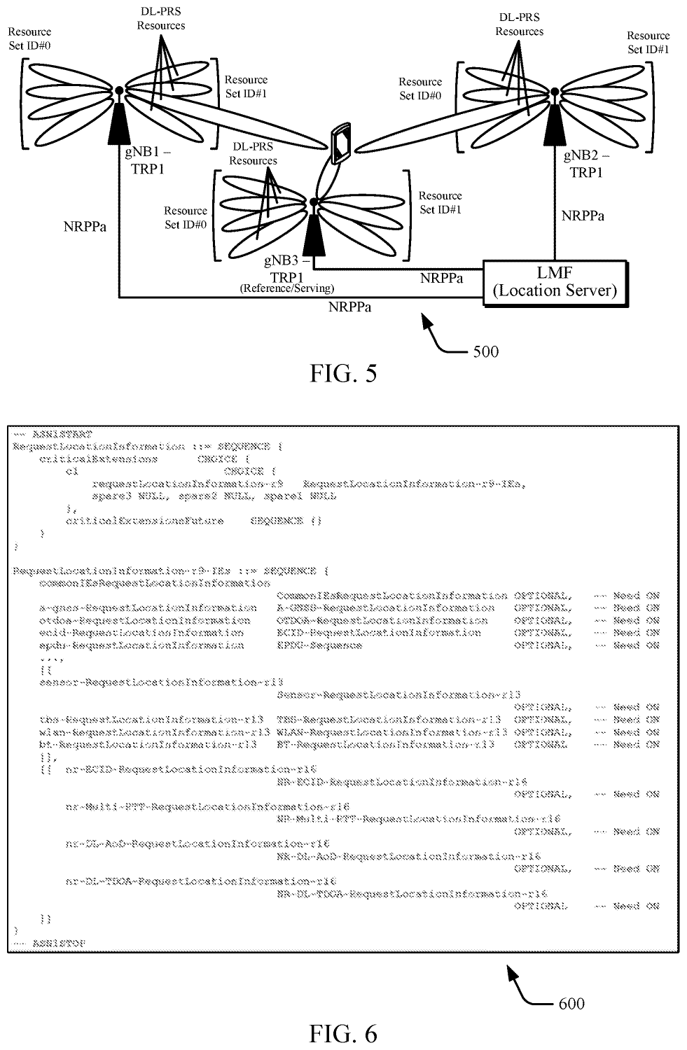

FIG. 5 illustrates an example of a system 500 of NR beam-based positioning as related to sidelink positioning reference unit management in accordance with aspects of the present disclosure. The system 500 illustrates a UE 104 and base stations 102 (e.g., gNB). The PRS can be transmitted by different base stations (serving and neighboring) using narrow beams over FR1 and FR2 as illustrated in the example system 500, which is relatively different when compared to LTE where the PRS was transmitted across the whole cell. The PRS can be locally associated with a PRS Resource identifier (ID) and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

The Tables T4 and T5 show the reference signal to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on global navigation satellite system (GNSS), inertial measurement unit (IMU) sensor, WLAN, and Bluetooth technologies for performing target device (UE) positioning.

TABLE T4
UE measurements to enable RAT-dependent positioning techniques.

| | | To facilitate support |
|---|---|---|
| DL/UL Reference | | of the positioning |
| Signals | UE Measurements | techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/ | UE Rx-Tx time difference | Multi-RTT |
| Rel.16 SRS for | | |
| positioning | | |
| Rel. 15 SSB/ | SS-RSRP (RSRP for RRM), | NR E-CID |
| CSI-RS for RRM | SS-RSRQ (for RRM), | |
| | CSI-RSRP (for RRM), | |
| | CSI-RSRQ (for RRM), | |
| | SS-RSRPB (for RRM) | |

TABLE T5
gNB measurements to enable RAT-dependent positioning techniques.

| DL/UL Reference | | To facilitate support of the |
|---|---|---|
| Signals | gNB Measurements | positioning techniques |
| Rel. 16 SRS for | UL RTOA | UL-TDOA |
| positioning | | |
| Rel. 16 SRS for | UL SRS-REFERENCE | UL-TDOA, UL-AoA, |
| positioning | SIGNAL RECEIVED | Multi-RTT |
| | POWER (RSRP) | |
| Rel.16 SRS for | gNB Rx-Tx time | Multi-RTT |
| positioning, Rel.16 | difference | |
| DL PRS | | |
| Rel. 16 SRS for | AoA and ZoA | UL-AoA, Multi-RTT |
| positioning | | |

The RAT-dependent positioning techniques may utilize the 3GPP RAT and core network entities to perform the position estimation of the UE, which are differentiated from RAT-independent positioning techniques, which rely on GNSS, IMU sensor, WLAN, and Bluetooth technologies for performing target device (UE) positioning. Network-assisted GNSS methods make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. Different GNSSs (e.g. GPS, Galileo, etc.) can be used separately or in combination to determine the location of a UE.

Barometric pressure sensor positioning makes use of barometric sensors to determine the vertical component of the position of the UE. The UE measures barometric pressure, optionally aided by assistance data, to calculate the vertical component of its location or to send measurements to the positioning server for position calculation. This method can be combined with other positioning methods to determine the 3D position of the UE. WLAN positioning makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server, to determine its location.

Bluetooth positioning makes use of Bluetooth measurements (beacon identifiers and optionally other measurements) to determine the location of the UE. The UE measures received signals from Bluetooth beacons. Using the measurement results and a references database, the location of the UE 104 is calculated. The Bluetooth methods may be combined with other positioning methods (e.g., WLAN) to improve positioning accuracy of the UE. TBS positioning consists of a network of ground-based transmitters, broadcasting signals only for positioning purposes. The current type of TBS positioning signals are the MBS (Metropolitan Beacon System) signals and Positioning Reference Signals (PRS). The UE measures received TBS signals, optionally aided by assistance data, to calculate its location or to send measurements to the positioning server for position calculation. Motion sensor positioning makes use of different sensors such as accelerometers, gyros, magnetometers, to calculate the displacement of UE 104. The UE 104 estimates a relative displacement based upon a reference position and/or reference time. The UE 104 sends a report comprising the determined relative displacement which can be used to determine the absolute position. This method can be used with other positioning methods for hybrid positioning.

With reference to a conceptual overview of the current Uu implementation (release 16), the overall measurement configuration and reporting is performed per configured RAT-dependent positioning method and/or RAT-independent positioning method.

FIG. 6 illustrates an example 600 of a LTE positioning protocol (LPP) request location information (RequestLocationInformation) message as related to sidelink positioning reference unit management, as described herein. The RequestLocationInformation message body in a LPP message is used by the location server to request positioning measurements or a position estimate from the target device.

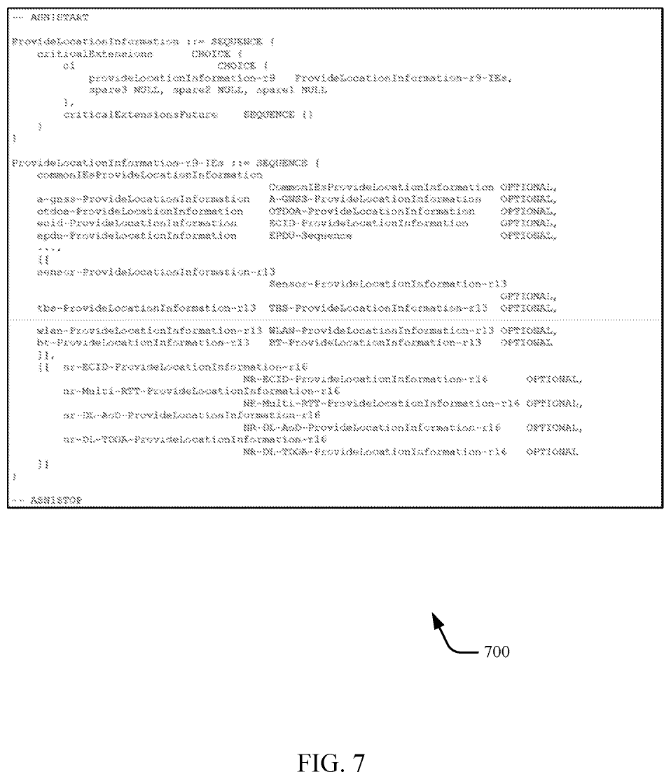

FIG. 7 illustrates an example 700 of a LPP provide location information (ProvideLocationInformation) message as related to sidelink positioning reference unit management, as described herein. The ProvideLocationInformation message body in a LPP message is used by the target device to provide positioning measurements or position estimates to the location server.

With reference to RAT-dependent positioning measurements, the different downlink measurements, including DL PRS RSRP, downlink RSTD, and UE Rx-Tx time difference required for the supported RAT-dependent positioning techniques are shown in Table T6. The measurement configurations may include four (4) pair of downlink RSTD measurements performed per pair of cells, and each measurement is performed between a different pair of downlink PRS resources or resource sets with a single reference timing; and eight (8) downlink PRS reference signal received power (RSRP) measurements can be performed on different downlink PRS resources from the same cell.

TABLE T6
Downlink measurements for downlink-based positioning techniques.
DL PRS reference signal received power (DL PRS-RSRP)

| | |
|---|---|
| Definition | DL PRS-RSRP, is the linear average over the power |
| | contributions (in [W]) of the resource elements that |
| | carry DL PRS reference signals configured for RSRP |
| | measurements within the considered measurement |
| | frequency bandwidth. |
| | For frequency range 1, the reference point for the DL |
| | PRS-RSRP shall be the antenna connector of the UE. |
| | For frequency range 2, DL PRS-RSRP shall be measured |
| | based on the combined signal from antenna elements |
| | corresponding to a given receiver branch. For frequency |
| | range 1 and 2, if receiver diversity is in use by the UE, |
| | the reported DL PRS-RSRP value shall not be lower |
| | than the corresponding DL PRS-RSRP of any of the |
| | individual receiver branches. |
| Applicable | RRC_CONNECTED intra-frequency, |
| for | RRC_CONNECTED inter-frequency |

DL reference signal time difference (DL RSTD)

| | |
|---|---|
| Definition | DL reference signal time difference (DL RSTD) is the |
| | DL relative timing difference between the positioning |
| | node j and the reference positioning node i, defined as |
| | T_{SubframeRxj} − T_{SubframeRxi}, |
| | Where: |
| | T_{SubframeRxj} is the time when the UE receives the start of |
| | one subframe from positioning node j. |
| | T_{SubframeRxi} is the time when the UE receives the |
| | corresponding start of one subframe from positioning |
| | node i that is closest in time to the subframe received |
| | from positioning node j. |
| | Multiple DL PRS resources can be used to determine the |
| | start of one subframe from a positioning node. |
| | For frequency range 1, the reference point for the DL |
| | RSTD shall be the antenna connector of the UE. For |
| | frequency range 2, the reference point for the DL RSTD |
| | shall be the antenna of the UE. |
| Applicable | RRC_CONNECTED intra-frequency |
| for | RRC_CONNECTED inter-frequency |

UE Rx − Tx time difference

| | |
|---|---|
| Definition | The UE Rx − Tx time difference is defined as T_{UE-RX} − |
| | T_{UE-TX} |
| | Where: |
| | T_{UE-RX} is the UE received timing of downlink subframe |
| | #i from a positioning node, defined by the first detected |
| | path in time. |
| | T_{UE-TX} is the UE transmit timing of uplink subframe #j |
| | that is closest in time to the subframe #i received from |
| | the positioning node. |
| | Multiple DL PRS resources can be used to determine the |
| | start of one subframe of the first arrival path of the |
| | positioning node. |
| | For frequency range 1, the reference point for T_{UE-RX} |
| | measurement shall be the Rx antenna connector of the |
| | UE and the reference point for T_{UE-TX} measurement shall |
| | be the Tx antenna connector of the UE. For frequency |
| | range 2, the reference point for T_{UE-RX} measurement shall |
| | be the Rx antenna of the UE and the reference point for |
| | T_{UE-TX} measurement shall be the Tx antenna of the UE. |
| Applicable | RRC_CONNECTED intra-frequency |
| for | RRC_CONNECTED inter-frequency |

In aspects of sidelink anchor device management, this disclosure details techniques for anchor and reference devices being registered, identified, and managed based on the type of positioning method applied, as well as the number of positioning nodes involved in a sidelink positioning session, and taking into account the configuration and reporting of anchor devices for in-coverage, partial coverage, and out-of-coverage scenarios. With reference to sidelink positioning, the selection and configuration of the anchor devices is essential to obtain high absolute and relative positioning accuracy. Aspects of the disclosure include implementations to identify, select, and configure an anchor device for multiple, different sidelink positioning methods. Additionally, the disclosure provides techniques to coordinate and manage multiple anchor devices including reference anchor devices using layer 1 and layer 2 identifiers. The disclosure also provides techniques for sidelink anchor device reporting including the signaling of real time difference information to assist in improved absolute and/or relative location estimation accuracy. Further, the disclosure provides to support anchor device capability exchange with other UEs, devices, and network entities via sidelink (PC5 interface), including the content of anchor device capability information.

In terms of the described techniques, an initiating device initiates a sidelink positioning and ranging session, and a responding device responds to the sidelink positioning and ranging session from the initiating device. Additionally, an anchor device facilitates a sidelink positioning session with a known location. Further, the described implementations for sidelink anchor device management may be implemented in combination to support NR RAT-independent positioning over the sidelink (PC5) interface. In this disclosure, a positioning-related reference signal may be referred to as a reference signal used for positioning procedures and/or purposes in order to estimate a target-UE's location, such as based on positioning reference signals (PRS), or based on existing reference signals, such as a channel state information reference signal (CSI-RS) or a sounding reference signal (SRS). A target-UE may be referred to as the device or network entity to be localized or positioned. In implementations, the term PRS can refer to any signal, such as a reference signal, which may or may not be used primarily for positioning. A target-UE may also be referred to as a UE of interest or any other node of interest, having a position (absolute or relative) that is to be obtained by the network or by the UE itself.

In aspects of the present disclosure, an anchor device can be implemented to support various functionality in a network, supporting SL (PC5 interface) positioning. An anchor device configuration can be performed by a configuration device entity, which may be an initiating UE, a roadside unit, a base station, a location server, a gNB-CU/DU, and the like. The configuration entity can configure the anchor device with the time-frequency resources for transmitting the sidelink positioning reference signals (SL PRS), including time duration and interval, in which the SL PRS is to be transmitted. The anchor device may additionally share various types of pre-defined configuration and/or assistance information with other devices that are participating or involved in a sidelink positioning session. The pre-defined configuration and/or assistance information may include 2D/3D latitude and longitude information; velocity estimates including an indication of mobility (e.g., high, medium, or low); the type of anchor device (e.g., roadside unit, UE); antenna and panel related information, including antenna panel locations, orientations, or the like. In the case of SL-TDOA, the anchor node may additionally share an indication as to whether it is a reference anchor node.

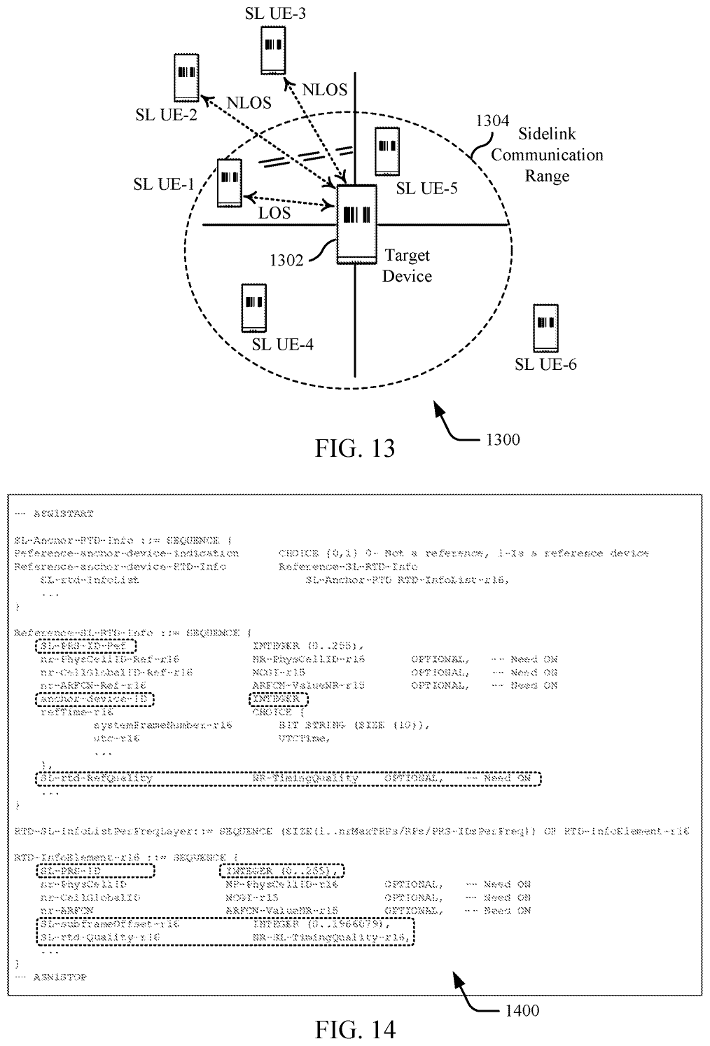

Anchor device identification, selection, and configuration can include procedures to identify and configure nearby anchors with respect to a target device. A network entity, such as a gNB or location server (e.g., a LMF) may provide a list of candidate anchor devices to the target device. The network entity may be aware of an anchor device via capability signaling, such as via RRC, LPP, MAC CE or the like, as described in more detail below. Any network entity, such as a gNB or LMF may act as a client or consumer of sidelink positioning information and request that a plurality of devices, such as UEs, signal their anchor device related parameters as mentioned above, if available. A network entity may also configure normal sidelink UEs and/or devices to operate as anchor devices based on the relative location with respect to the target device, which provides the most spatial diversity. This may be based on one or more selection and/or configuration criteria, as described following with reference to FIG. 13.

This techniques discussed herein detail solutions for anchor and reference devices to be registered, identified and managed based on the type of positioning method applied as well as the number of positioning nodes, which are involved. These techniques include configuring a SL PRU 116 to perform SL reference positioning measurements including the reporting known location information to a configuration entity. These techniques further include performing timing and receiver error correction using a SL positioning reference unit. These techniques further include managing multiple SL PRUs including reference anchor devices using layer 1 and layer 2 identifiers. These techniques further include supporting request and reporting of SL positioning reference measurements from a SL PRU 116. These techniques further include supporting reference device capability exchange between a SL positioning reference unit and a configuration entity.

In the discussions herein, an initiator device initiates a SL positioning or ranging session, and a responder device responds to a SL positioning or ranging session from an initiator device. Additionally, the various implementations discussed herein may be used in combination with each other to support NR RAT-independent positioning over the SL (PC5) interface. Furthermore, for the discussions herein, a positioning-related reference signal may be referred to as a reference signal used for positioning procedures or purposes in order to estimate a target-UE's location, e.g., PRS, or based on existing reference signals such as channel state information reference signal (CSI-RS) or SRS. A target-UE or target device may be referred to as the device or entity to be localized or positioned. In various embodiments, the term ‘PRS’ may refer to any signal such as a reference signal, which may or may not be used primarily for positioning. Additionally, in the discussions herein, a target-UE may be referred to as a UE of interest whose position (absolute or relative) is to be obtained by the network or by the UE itself.

With regard to SL positioning reference unit configuration, in one or more implementations a SL positioning reference unit supports the various functionality. This functionality may include, for example, mitigation of transmitter (Tx) and receiver (Rx) clock errors brought about by clock imperfections and residual errors at both the initiator and responder UEs. This functionality may also include mitigation of angular error and/or orientation errors via exploiting known location and antenna orientation properties of a positioning reference unit. This functionality may also include dynamically configuring devices participating in a SL positioning session (e.g., one or more of initiator device, responder device, or anchor device) to be a SL positioning reference unit subject to a UE capability.

This functionality is enabled via the SL PRU 116 providing the known location to the configuration entity and/or positioning calculation entity. The known location information may comprise at least one of: 2D or 3D latitude and longitude information; height or altitude information; velocity estimates including (e.g., indication of mobility, such as high, medium or low); antenna and panel related location information and reference points including antenna panel locations including distributed antenna locations, antenna panel orientations or the like; SL Antenna reference points including any associated SL antenna reference point (ARP) IDs, which may be used to define the SL TRP location (in the x,y,z plane) and may be associated to the SL-PRS resources; or uncertainty and/or confidence intervals associated to the above know location information, which defines quality of the provided known location.

Multiple different scenarios or modes are identified in which to support the SL positioning reference unit. In one or more implementations, the SL PRU 116 operates in a UE-based UE-configured mode. A UE 104 or device supporting SL positioning performs RAT-dependent and/or RAT-independent measurements provided by another configuration UE 104 or device, such as, an anchor UE 104, a reference UE 104, a target-UE 104, a roadside unit, and so forth. In this scenario or mode, the absolute and/or relative positioning calculation entity may be the UE 104 receiving the normal SL positioning measurement and reference SL positioning measurement reports and computing the target-UE 104's absolute and/or relative location information. The SL PRU 116 performs SL reference measurements, which have been configured by the same configuration UE 104 or device to be used to provide correction information to the positioning calculation entity.

Additionally or alternatively, the SL PRU 116 operates in a UE-based network configured mode. A UE 104 or device supporting SL positioning performs RAT-dependent and/or RAT-independent measurements provided by one or more network entities, such as a base station 102 (e.g., gNBs), a location server, a reference station, a reference TRP, or roadside units via positioning assistance data or measurement configuration signaling. In this scenario or mode, the absolute and/or relative positioning calculation entity may be the UE 104 receiving the normal SL positioning measurement and reference SL positioning measurement reports and computing the target-UE 104's absolute and/or relative location information. The SL PRU 116 performs SL reference measurements, which have been configured by the same one or more aforementioned network entities to be used to provide correction information to the positioning calculation entity.

Additionally or alternatively, the SL PRU 116 operates in a UE-assisted UE-configured mode. A UE 104 or device supporting SL positioning performs RAT-dependent and/or RAT-independent measurements provided by another configuration UE 104 or device, such as an anchor UE 104, a reference UE 104, a target-UE 104, a roadside unit, and so forth. In this scenario or mode, the absolute and/or relative positioning calculation entity may be a network entity, such as one or more of a base station 102 (e.g., gNBs), a location server, a reference station, a reference TRP, or roadside units receiving the normal SL positioning measurement and reference SL positioning measurement reports and computing the target-UE 104's absolute and/or relative location information. The SL PRU 116 performs SL reference measurements, which have been configured by the same configuration UE 104 or device to be used to provide correction information to the positioning calculation entity.

Additionally or alternatively, the SL PRU 116 operates in a UE-assisted network configured mode. A UE 104 or device supporting SL positioning performs RAT-dependent and/or RAT-independent measurements configured by one or more network entities such as a base station 102 (e.g., gNBs), a location server, a reference station, a reference TRP, or a roadside units via positioning assistance data or measurement configuration signaling. In this scenario or mode, the absolute and/or relative positioning calculation entity may be a network entity, such as one or more of a base station 102 (e.g., gNBs), a location server, a reference station, a reference TRP, or roadside units receiving the normal SL positioning measurement and reference SL positioning measurement reports and computing the target-UE 104's absolute and/or relative location information. The SL PRU 116 performs SL reference measurements, which have been configured by the same one or more aforementioned network entities to be used to provide correction information to the positioning calculation entity.

Additionally or alternatively, the SL PRU 116 may pre-configured to perform SL positioning reference signal measurements according to the configured positioning technique, e.g., SL-TDoA, SL-RTT, SL-AoA or the like. In this case, the SL positioning reference measurements may comprise of SL-RSTD, SL UE Rx-Tx time difference, SL Time-of-flight (ToF) or Time-of-Arrival (ToA) measurements, SL-Angle-of-arrival measurements or the like.

The described correction information derived from the SL PRU 116 provided by the configuration entity to the positioning calculation entity and may comprise one or more of pseudo-range errors; synchronization timing errors between anchor devices and positioning reference units; correction of RSTD reference measurements including between a reference anchor node and other anchor nodes; SL TRP Tx timing error difference between a pair of reference anchor node (TRP) and another anchor node (TRP) (e.g., these may also include timing error group (TEG) information and may comprise of Tx and Rx TEGs); AOA calibration errors and uncertainty ranges or windows; time validity duration of the sidelink correction information indicated via one or more time bases, e.g., UTC time, date information or time windows; the type of SL PRU 116, e.g., UE, roadside unit (RSU), CPE or the like; or the PRU ID indicating the source of the reference measurements.

In the discussions herein, Tx/Rx error mitigation is performed using a SL PRU 116. The SL PRU 116 may perform reference measurements with respect to the anchor devices, which will be used to derive the correction information by the configuration or positioning calculation entity. The transmitter and receiver imperfections are modelled by the baseband clock error (ε), reception timing delay errors (τ) between baseband and RF antenna as well as UE 104 or device measurement error (β). This UE 104 or device measurement error (β) refers to a measurement error inherent in the UE 104 or device when measuring a timing parameter. In addition, the propagation delays P_{delay} over the air interface are considered for transmitting the SL PRS signals from both SL anchor device 1 (SL_{Anc1}) and SL anchor device 2 (SL_{Anc2}). Although only two anchor devices are discussed, it should be noted that additional anchor devices may also be used, in which case additional equations analogous to those below are included and the results incorporated into the double differential error below.

The SL TOA (time-of-arrival) at the target UE 104 (T-UE) can be modelled as:

$${SL\_TOA}_{S {L}_{A n c 1} \to T - U E} = ( {ε}_{S {L}_{A n c 1}} + {τ}_{S {L}_{A n c 1}} ) + {P}_{Anch 1 \_ delay \to T - U E} + ( {ε}_{S {L}_{T - U E}} + {τ}_{S {L}_{T - U E}} ) + {β}_{A nch 1 - T - U E}$$

$${SL\_TOA}_{S {L}_{A n c 2} \to T - U E} = ( {ε}_{S {L}_{A n c 2}} + {τ}_{S {L}_{A n c 2}} ) + {P}_{Anch 2 \_ delay \to T - U E} + ( {ε}_{S {L}_{T - U E}} + {τ}_{S {L}_{T - U E}} ) + {β}_{A n c h 2 - T - U E}$$

The SL TOA (time-of-arrival) at the SL PRU 116 (SL-PRU) can be modelled as:

$${SL\_TOA}_{S {L}_{A n c 1} \to S L - P R U} = ( {ε}_{S {L}_{A n c 1}} + {τ}_{S {L}_{A n c 1}} ) + {P}_{Anch 1 \_ delay \to SL - PRU} + ( {ε}_{S L - P R U} + {τ}_{S L - P R U} ) + {β}_{A n c h 1 - S L - P R U}$$

$${SL\_TOA}_{S {L}_{A n c 2} \to S L - P R U} = ( {ε}_{S {L}_{A n c 2}} + {τ}_{S {L}_{A n c 2}} ) + {P}_{Anch 2 \_ delay \to S L - P R U} + ( {ε}_{S L - P R U} + {τ}_{S L - P R U} ) + {β}_{A n c h 2 - S L - P R U}$$

The SL RSTD at both SL PRU 116 and T-UE is indicated as:

$${SL\_RSTD}_{T - U E} = {SL\_TOA}_{S {L}_{A n c 1} \to T - U E} - {SL\_TOA}_{S {L}_{A n c 2} \to T - U E}$$

$${SL\_RSTD}_{S L - P R U} = {SL\_TOA}_{S {L}_{A n c 1} \to S L - P R U} - {SL\_TOA}_{S {L}_{A n c 2} \to S L - P R U}$$

The configuration entity or positioning calculation entity will be able to compute the double differential error by taking the difference between the SL RSTD measurements of the SL target UE and SL PRU 116 UE as follows:

$${δ}_{Diff - C o r r} = S {L}_{R S T {D}_{T - U E}} - S {L}_{R S T {D}_{S L - P R U}} = ( {P}_{Anch 1 \_ delay \to T - U E} - {P}_{Anch 2 \_ delay \to T - U E} + {β}_{A n c h 1 - T - U E} - {β}_{A n c h 2 - T - U E} ) - ( {P}_{Anch {1}_{delay} \to SL - P R U} - {P}_{Anch {2}_{delay} \to SL - P R U} + {β}_{A n c h 1 - S L - P R U} - {β}_{A n c h 2 - S L - P R U} )$$

As noted in the above equation, the configuration/positioning calculation entity will be able remove any resulting clock error(s) and reception timing delay errors (t) between the baseband and RF antenna. Accordingly, the clock error(s) and reception timing delay errors (t) between the baseband and RF antenna are removed without needing knowledge of what those errors are.

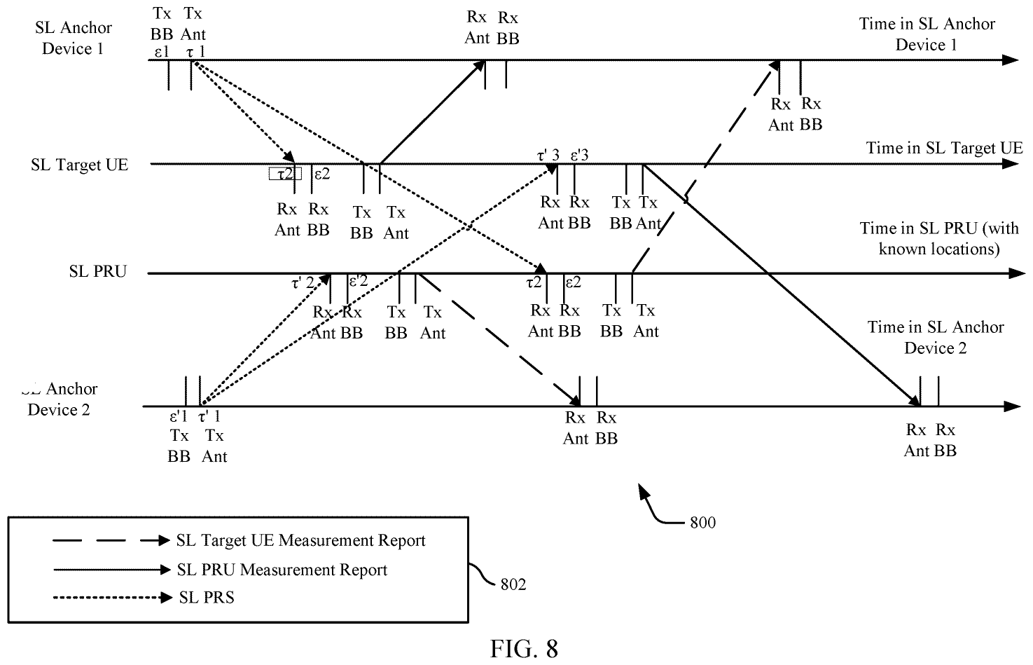

FIG. 8 illustrates an example 800 of SL timing error corrections using SL PRU as related to sidelink positioning reference unit management. The SL timing error corrections are the error corrections discussed above. In the example 800, a legend 802 is illustrated showing that solid arrows refer to SL PRU measurement reports, large-dashed arrows refer to SL target UE measurement reports, and small-dashed arrows refer to SL PRS. Also in the example 800 Ant refers to antenna and BB refers to baseband. As illustrated in the example 800, SL PRS are transferred from the anchor devices to the SL PRU as well as the SL target UE. The SL target UE transmits SL target UE measurement reports to the SL anchor devices, and the SL PRU transmits SL PRU measurement reports to the SL anchor devices.

In one or more implementations, a SL PRU 116 has an ID. The SL PRU 116 device may have varying degrees of mobility and therefore the applicability of the SL PRU 116 device may be time varying depending on the range and measurement quality with respect to the target device or group of target devices. The switch to another SL PRU 116 device may be event triggered, which relies on a particular configured threshold provided by the network to be exceeded, e.g., if the SL RSRP of the nearby SL PRU 116 node (with respect to the SL target device) is lower than a configured threshold then a new SL PRU 116 device may be selected. The configuration parameters for the SL PRU 116 handover or switchover may include the measurement value by the device, hysteresis value to prevent frequent handovers or switchovers and the threshold value for the event. Additionally or alternatively, another complementary event may be specified when the measurement value is higher than the threshold. Due to the potential variable number of SL PRU 116 devices, in proximity to a target device, it is proposed that an SL PRU ID be associated with an PRU in order to differentiate among different PRUs.

In one implementation, the SL PRU 116 may comprise a L1-ID derived from L2-ID. For example, a subset of bits (e.g., most-significant bit or least-significant bit) of the L2-ID may be associated with L1-ID. In this case both a L2-ID and L1-ID may be associated with the SL PRU 116.

Additionally or alternatively, the SL PRU ID may comprise a self-generated ID by the device, which may also be different to as a source-ID used for sidelink communication, which may also be self-generated.

Additionally or alternatively, the SL PRU ID may comprise of an application ID (APP ID) generated by an SL positioning or ranging application within the device, e.g., in the V2X or proximity service (ProSe) application layer. The is applicable to groupcast SL positioning or ranging sessions, where the application layer is responsible for the creation of the member UE IDs within a group, which may be separately identified by a Group ID. In this case, the SL PRU ID may be a subset of the SL PRU ID or have an association with respect to the group ID.

Furthermore, since the SL PRU 116 may continuously change roles depending on whether the target device is within a reasonable coverage of the anchor devices, the SL PRU 116 devices may provide a further real-time indication to the network entities or other UEs on whether they are acting as SL PRU 116 or not. It should be noted that this indication is different from the capability signaling discussed herein, where a device may indicate its capability of being an SL PRU 116 device. The described procedures including the sharing of IDs, provisioning of the network threshold configuration and real time indication may be signaled using any of a variety of signaling, such as RRC, PC5 RRC, LPP, PC5-S, or medium access control element (MAC CE) signaling depending on whether the information is provided or received by a network entity or by a device or UE 104.

In one or more implementations, a SL PRU 116 device may also report information via the SL interface to UEs, devices, or anchor devices as well as the network (via Uu interface). The reference measurements may be separately requested via a separate measurement configuration message and the SL PRU 116 may respond accordingly with a separate reporting message containing the reference measurements. The SL PRU 116 may report such information to either a configuration entity or positioning calculation entity. The request and response signaling of the SL positioning reference measurements may be achieved using, for example, RRC, PC5 RRC, LPP, PC5-S, or MAC CE signaling.

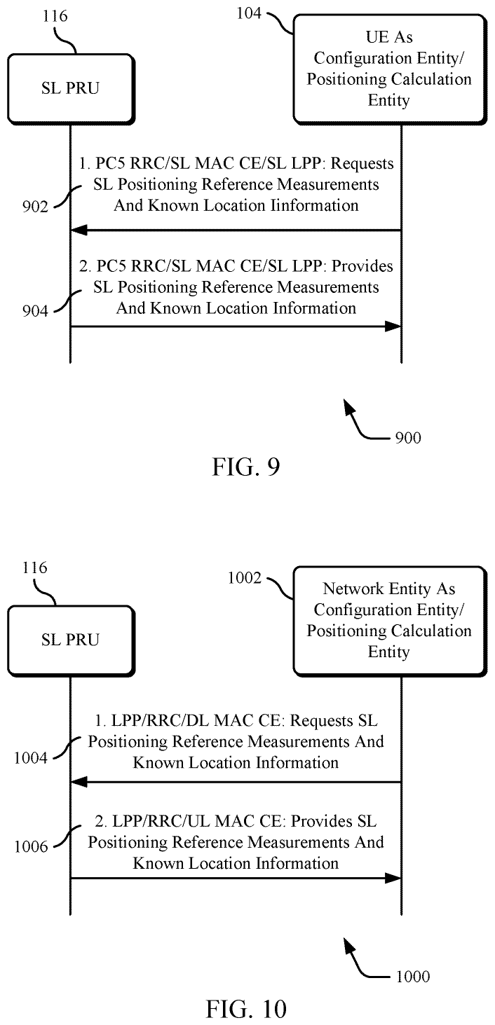

FIG. 9 illustrates an example 900 of a type of request and response signaling exchange for reference measurements between a configuration entity or positioning calculation entity and a SL PRU 116 as related to sidelink positioning reference unit management. The example 900 includes a SL PRU 116 and a UE 104, and shows SL PRU 116 reference measurement and known location exchange with a UE 104 or device as the configuration entity or positioning calculation entity.

The UE 104 transmits a request 902 to the SL PRU 116 for SL positioning reference measurements and known location information of the SL PRU 116. The request 902 is transmitted, for example, using PC5 RRC, SL MAC CE, or SL LPP signaling. The SL PRU 116 collects the requested SL positioning reference measurements and transmits a response 904 to the UE 104 providing the SL positioning reference measurements and known location information of the SL PRU 116. The response 904 is transmitted, for example, using PC5 RRC, SL MAC CE, or SL LPP signaling.

Additionally or alternatively, a dedicated SL positioning protocol (SL LPP) may be used to signal request and response of SL reference measurements from the SL PRU 116.

FIG. 10 illustrates an example 1000 of another type of request and response signaling exchange for reference measurements between a configuration entity or positioning calculation entity and a SL PRU 116 as related to sidelink positioning reference unit management. The example 1000 includes a SL PRU 116 and a network entity 1002, and shows a SL PRU 116 reference measurement and known location exchange with a network node as the configuration entity or positioning calculation entity. The network entity 1002 can be any of a variety of network nodes, such as a base station 102 (e.g., gNB).

The network entity 1002 transmits to the SL PRU 116 a request 1004 for SL positioning reference measurements and known location information of the SL PRU 116. The request 1004 is transmitted, for example, using LPP, RRC, or DL MAC CE signaling. The SL PRU 116 collects the requested SL positioning reference measurements and transmits a response 1006 to the UE 104 providing the SL positioning reference measurements and known location information of the SL PRU 116. The response 1006 is transmitted, for example, using LPP, RRC, or DL MAC CE signaling.

Returning to FIG. 1, in one or more implementations the SL PRU 116 supports periodical reporting, semi-persistent or immediate reporting mechanisms via, for example, RRC, PC5 RRC, LPP, PC5-S, or MAC CE signaling. In addition, other parameters that may be reported include one or more of validity time of SL PRU 116 device based on different time bases; mobility state; or area ID or zone ID associated with anchor ID, for pre-configuration anchor devices may be allowed to operate in different areas based on area ID, list of camped cells, zone ID, public land mobile network (PLMN) ID, or any geographical region identifier.

Additionally or alternatively, the SL PRU 116 device may dynamically update its known location and antenna orientation information based on the applicable mobility. Dynamic location and antenna orientation updates may include one or more of 2D or 3D location information, including latitude and longitudinal information, antenna locations, distributed antenna (DAS) locations, device antenna panel information, or the like. The location updates may be event triggered based on delta locations compared to the previously reported locations.

In one or more implementations, the SL PRU 116 may provide its capability information of acting as an SL PRU 116 to a configuration entity, such as a UE 104, a base station 102, a location server (e.g., LMF), and so forth. The SL PRU 116 may provide its capability information of acting as an SL PRU 116 using via solicited and/or unsolicited signalling to other UEs (SL devices) via the SL (PC5) interface, or via solicited and/or unsolicited signalling to network entities such as the base station 102 (e.g., using RRC signalling) and/or LMF (e.g., using LPP signalling)

In addition, this capability information may be used to inform the network and/or other UEs 104 or devices that there are SL PRUs in the vicinity and can extend to in-coverage, partial coverage and out-of-coverage scenarios. Dynamic indications may be used via the aforementioned signalling mechanisms to indicate whether a UE 104 or device is acting as a SL PRU 116 at any given time (e.g., as discussed above).

Additionally or alternatively, the SL PRU 116 may provide its known location information using the capability information exchange.

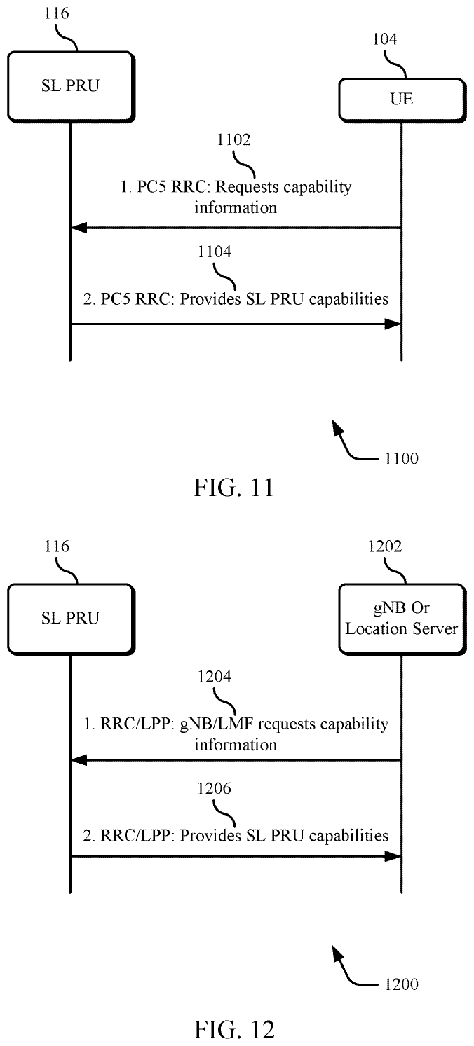

FIG. 11 illustrates an example 1100 of a type of capability exchange for a SL positioning reference unit as related to sidelink positioning reference unit management. The example 1100 includes a SL PRU 116 and a UE 104, and shows a solicited request for SL PRU 116 capability information via SL (PC5) interface.

The UE 104 transmits a request 1102 to the SL PRU 116 for SL capability information. The request 1102 is transmitted, for example, using PC5 RRC signaling. The SL PRU 116 transmits a response 1104 to the UE 104 providing the capability information of the SL PRU 116. The response 1104 is transmitted, for example, using PC5 RRC signaling.

Additionally or alternatively, a dedicated SL positioning protocol may be used to signal SL PRU 116 device capability information.

FIG. 12 illustrates an example 1200 of another type of capability exchange for a SL positioning reference unit as related to sidelink positioning reference unit management. The example 1200 includes a SL PRU 116 and a network entity 1202 that is a base station 102 (e.g. a gNB) or a location server, and shows a solicited request for SL PRU 116 information via Uu interface using RRC or LPP signalling.

The network entity 1202 transmits to the SL PRU 116 a request 1204 for SL capability information. The request 1204 is transmitted, for example, using RRC or LPP signaling. The SL PRU 116 transmits a response 1206 to the UE 104 providing the capability information of the SL PRU 116. The response 1206 is transmitted, for example, using RRC or LPP signaling.

In one or more implementations, the PRU capabilities include supported SL positioning methods, e.g., SL-TDoA, SL-RTT (single-sided and/or double-sided), SL-AoA, and so forth. The PRU capabilities may also include supported hybrid positioning modes including one or more of the above SL positioning and/or Uu positioning techniques. Additionally or alternatively, the PRU capabilities include supported positioning modes of the anchor device as discussed above including UE-based UE-configured, UE-based network-configured, UE-assisted UE-configured, UE-assisted network-configured. Additionally or alternatively, the PRU capabilities include supported SL reference measurement capabilities, e.g., including a list of supported bands including FR1 and FR2. Additionally or alternatively, the SL PRU 116 may also be capable of performing Uu reference measurements in addition to SL reference measurements.

Additionally or alternatively, the PRU capabilities include supported SL PRS processing capabilities (if applicable). Additionally or alternatively, the PRU capabilities include supported reporting modes including periodical, semi-persistent and one-shot reporting. Additionally or alternatively, the PRU capabilities include capability of jointly acting as a positioning reference unit for Uu and SL positioning methods. Additionally or alternatively, the PRU capabilities include supported number of per pair of SL RSTD measurements.

Additionally or alternatively, the PRU capabilities include mobility type (e.g., static or mobile). Additionally or alternatively, the PRU capabilities include location source (e.g., RAT-dependent/RAT-independent methods, per-configured/offline/calibration). Additionally or alternatively, the PRU capabilities include anchor device type (e.g., UE, RSU, CPE). Additionally or alternatively, the PRU capabilities include the SL PRU ID (e.g., signaled as part of the capability message). Additionally or alternatively, the PRU capabilities include an indication that the device may operate in-coverage, out-of-coverage and/or in partial coverage scenarios. Additionally or alternatively, the PRU capabilities include known location information as described above.

FIG. 13 illustrates an example 1300 of sidelink anchor devices identification with respect to a target device, which supports sidelink anchor device management in accordance with aspects of the present disclosure. In this example, several sidelink UEs, identified as SL UE-1 through SL UE-6, may be sidelink anchor device candidates with respect to a target device 1302. Anchor devices can be selected and configured based on received sidelink positioning measurements, such as from the target device 1302, and the received sidelink positioning measurements indicate whether an anchor device (or anchor device candidate) has a line-of-sight (LOS) or no line-of-sight (NLOS) link with respect to the target device. In this case, the network entity may preferably configure anchor devices with a LOS link to the target device. In an implementation, the target device 1302 may indicate a preferred list of anchor devices to the network based on the sidelink positioning measurements by the target UE, or may explicitly separately indicate individual devices to the network. In another implementation, the target device 1302 may indicate identified anchors to the network based on ProSe discovery model A and model B communications. The trigger in this case may be received from higher layers (e.g., ProSe Application layer). The anchor devices may also be selected based on a sidelink communication range 1304 with respect to the target device (target UE), where candidate or potential devices outside the sidelink communication range will be less preferred as anchor nodes when compared to devices within the sidelink communication range.

A network entity may also configure normal sidelink UEs and/or devices based on the positioning technique, which affects the number of anchor nodes required to be selected, such as at least three anchor nodes for SL-TDoA, and at least one anchor node for SL-AoA and SL-RTT. A network entity may also configure normal sidelink UEs and/or devices based on their capabilities as further described below, and/or based on their proximity as described above with reference to selection and/or configuration criteria. For example, the sidelink UEs (e.g., SL UE-1, SL UE-4, and SL UE-5) within the sidelink communication range 1304 of the target device 1302 can be selected as anchor devices based on the above criteria for TDOA. In another implementation, a gNB and location server may request a list of possible anchor devices via operator administration and maintenance (OAM).

In an alternative implementation, application functions (AFs) and network functions (NFs) may access a sidelink positioning information service, including anchor list information via a gateway mobile location center (GMLC) in the same trust domain (e.g., in the same PLMN) using the Ngmlc interface or Event Exposure with location information from an AMF in the same trust domain using the Namf interface. In this case, the gNB and/or the LMF may act as LCS clients. In another implementation, the anchor devices may be selected based on the quality of links between each of the sidelink anchor device candidates (e.g., the links between SL UE-1 and SL UE-4, SL UE-4 and SL UE-5, and SL UE-1 and SL UE-5) may be evaluated based on RSS measurement quality, BLER, etc. and used as anchor device selection criteria. This is to ensure that for methods such as SL-TDOA, the transmit time offset between anchor devices is kept to a minimum and the synchronization timing errors are kept as low as possible. In another implementation, the anchor devices may be selected based on the coverage scenario. An indication may be transmitted from the anchor device to applicable sidelink positioning devices (e.g., initiator device or responder devices) whether it is in-coverage, partial coverage, or out-of-coverage. The network coverage of the anchor device may also be an additional criterion for selection. In a further extended implementation, the GNSS coverage may also be indicated, and in combination with the network coverage indication, can be used to select one or more of the anchor devices.

Similarly, for a groupcast sidelink positioning, where the group members are known beforehand via higher-layer signaling (e.g. by V2X, ProSe) application layer, the group members may also operate as anchor devices with respect to the target member device within the same group. In this case, anchor devices may be pre-configured and associated with some validity criteria (e.g., if the group disbands then a new list of anchor devices needs to be configured). In another implementation, the target UE or device may request nearby sidelink devices for anchor device indications of an anchor device via PC5 RRC/PC5-S signaling. For example, anchor device selection by UEs or devices participating in a sidelink positioning session including the target device, and a single reference anchor device may be selected from the selected plurality of anchor devices.

Four scenarios are identified in which to support anchor device identification, selection, and configuration as described herein. The scenarios include a first scenario for UE-based UE-configured anchor device management, in which a UE supporting sidelink positioning performs RAT-dependent and/or RAT-independent positioning based on sidelink measurements received by at least one or more anchor UE or devices (e.g., a UE, reference UE, roadside unit, or the like). In this scenario, the absolute and/or relative positioning calculation entity may be the UE performing the measurements and receiving the measurement reports based on SL PRS transmissions by UE configured anchor devices. The anchor device may be configured by other sidelink devices in proximity and may be beneficial for partial coverage and out-of-coverage UEs.

A second scenario is UE-based network-configured anchor device management, in which a UE supporting sidelink positioning performs RAT-dependent and/or RAT-independent positioning based on sidelink measurements received by at least one or more anchor UE or devices (e.g., a UE, reference UE, roadside unit, or the like). In this scenario, the absolute and/or relative positioning calculation entity may be the UE performing the measurements and receiving the measurement reports based on SL PRS transmissions by network configured anchor devices. The anchor device may be configured by a network entity in proximity and may be beneficial for partial coverage and in-coverage UEs. The network configuring entity may be base station (e.g., a gNB), a location server, a reference station, reference TRP, a roadside unit, or gNB-CU/DU.

A third scenario is UE-assisted UE-configured anchor device management, in which a UE supporting sidelink positioning performs RAT-dependent and/or RAT-independent positioning based on sidelink measurements received by at least one or more anchor UE or devices (e.g., a UE, reference UE, roadside unit, or the like). In this scenario, the absolute and/or relative positioning calculation entity may be the network entity (e.g., a gNB or LMF) receiving the Uu/SL measurements and/or receiving the measurement reports based on SL PRS transmissions by the UE configured anchor devices. The anchor device may be configured by other sidelink devices in proximity and may be beneficial for partial coverage and in-coverage UEs.

A fourth scenario is UE-assisted network-configured anchor device management, in which a UE supporting sidelink positioning performs RAT-dependent and/or RAT-independent positioning based on sidelink measurements received by at least one or more anchor UE or devices (e.g., a UE, reference UE, roadside unit, or the like). In this scenario, the absolute and/or relative positioning calculation entity may be the network entity (e.g., a gNB or LMF) receiving the Uu/SL measurements and/or receiving the measurement reports based on SL PRS transmissions by network configured anchor devices. The network configuring entity may be a base station (e.g., a gNB), a location server, a reference station, a reference TRP, a roadside unit, or gNB-CU/DU. This may be beneficial for partial coverage and in-coverage UEs.

In aspects of sidelink anchor device management, an anchor device and a target device may have varying degrees of mobility, and therefore the applicability of the anchor device may be time varying depending on the range and measurement quality with respect to the target device. The switch to another anchor device may be event triggered, which relies on a particular configured threshold provided by the network to be exceeded (e.g., if the SL RSRP of the serving anchor node is lower than a configured threshold then a new anchor device may be selected). The configuration parameters for the anchor handover or switchover may include the measurement value by the device, a hysteresis value to prevent frequent handovers or switchovers, and the threshold value for the event. Additionally, another complementary event may be specified when the measurement value is above or higher than the threshold. Due to the varying number of anchor devices in proximity to a target device, it is proposed that an anchor ID be associated to an anchor device in order to differentiate among different anchors.

In one implementation, the anchor device may comprise a layer one, L1-ID derived from a layer two, L2-ID. For example, a subset of bits (e.g., most significant bit (MSB) or a least significant bit (LSB)) of the L2-ID may be associated to L1-ID. In this case, both a L2-ID and L1-ID may be associated to an anchor device. In another implementation, the anchor device ID may be a self-generated ID by the device, which may also be different than a source-ID used for sidelink communication, which may also be self-generated. In another implementation, the anchor device ID may be an application ID (APP ID) (e.g., beneficial as a groupcast ID) generated by a sidelink positioning and/or ranging application within the device (e.g., V2X or ProSe application layer). This application ID is applicable to groupcast sidelink positioning and/or ranging sessions, where the application layer is responsible for the creation of the member UE IDs within a group, which may be separately identified by a group ID. In this case, the anchor device ID may be a subset of the group ID, or have an association with respect to the group ID. Furthermore, since the anchor device may continuously change roles depending on whether the target device is within a reasonable coverage of the anchor devices, it is also proposed that the anchor devices provide a further real-time indication as to whether they are operating as anchor devices or not. Note that this is different from the capability signaling (e.g., sidelink capability information transfer procedures of anchor devices) described below, where a device may indicate its capability of being an anchor device. The described procedures include the sharing of IDs, provisioning the network threshold configuration, and a real time indication may be signaled using RRC/PC5 RRC/LPP/PC5-S/MAC CE signaling depending on whether the information is provided or received by a network entity, device, or UE.

FIG. 14 illustrates an example 1400 of an implementation for signaling sidelink real time difference (RTD) information, which supports sidelink anchor device management in accordance with aspects of the present disclosure. In aspects of sidelink anchor device management, an anchor device may also report information via the sidelink interface to other anchor devices, as well as via the network (via Uu interface). An important parameter for reporting includes the RTD offset information between a pair of anchor nodes, such as a reference anchor node and another anchor node, which provides time synchronization information between a reference anchor device and another anchor device (e.g., to enable the sidelink TDoA measurements). The anchor devices may also report such information to a configuration entity or positioning calculation entity. The Table T5 below describes the sidelink RTD information field descriptions shown in the example 1400.

TABLE T5
Sidelink RTD Information Field Descriptions
SL-RTD-Info field descriptions

Reference-SL-RTD-Info
This field defines the reference TRP for the RTD and includes the
following sub-fields:
- SL-PRS-ID-Ref: used along with a SL-PRS Resource Set ID and a
SL-PRS Resources ID to uniquely identify a SL-PRS resource, and is
associated to the reference SL TRP or anchor device.
- nr-PhysCellId-Ref: specifies the physical cell identity of the reference
TRP.
- Anchor-device-ID: specifies anchor device ID.
- nr-CellGlobalId-Ref: specifies the NCGI, the globally unique identity
of a cell in NR, of the reference TRP.
- nr-ARFCN-Ref: specifies the NR-ARFCN of the TRP's CD-SSB
(as defined in TS 38.300 [47]) corresponding to nr-PhysCellID.
- refTime: specifies the reference time at which the rtd-InfoList is valid.
The systemFrameNumber choice refers to the SFN of the reference TRP.
- SL-rtd-RefQuality: specifies the quality of the timing of the reference
TRP, used to determine the RTD values provided in rtd-InfoList.
SL-PRS-ID
This field is used along with a SL-PRS Resource Set ID and a SL-PRS
Resources ID to uniquely identify a SL-PRS resource, and is associated
to the reference SL TRP/SL resource pool or anchor device. This ID can
be associated with multiple DL-PRS resource sets associated with a
single TRP for which the RTD-InfoElement is applicable.
nr-PhysCellID
This field specifies the physical cell identity of the associated SL anchor
device.
nr-CellGlobalID
This field specifies the NCGI, the globally unique identity of a cell in
NR, of the associated TRP for which the RTD-InfoElement is applicable.
The server should include this field if needed to resolve ambiguity in the
TRP indicated by nr-PhysCellID.
Anchor-device-ID
This represents a unique identifier of an anchor device in a cell based on
application requirements, etc.
nr-ARFCN
This field specifies the NR-ARFCN of the SL PRS resources
corresponding to nr-PhysCellID for which the RTD-InfoElement is
applicable.
SL-subframeOffset
This field specifies the subframe boundary offset at the SL TRP antenna
location and/or antenna connector between the reference SL TRP/SL
PRS resource or SL resource pool and a neighbor SL TRP/ SL PRS
resource pool in time units T_{c} = 1/(Δfₘₐₓ · N_{f} ) where Δfₘₐₓ = 480 · 10³ Hz
and N_{f} = 4096. The offset is counted from the beginning of a subframe
#0 of the reference TRP to the beginning of the closest subsequent
subframe of this neighbour TRP.
Scale factor 1 T_{c}.
SL-rtd-Quality
This field specifies the quality of the RTD from a pair of SL anchor.

The anchor device may report the real time difference between itself and another anchor device. Furthermore, anchor device reporting may support periodical reporting, semi-persistent, or immediate reporting mechanisms via RRC/PC5 RRC/LPP/PC5-S/MAC CE signaling. In addition, other parameters may be reported, including a validity time of the anchor device based on different time bases, a number of served target devices, a mobility state, and/or an area ID or zone ID (for geographical) associated with the anchor ID. For pre-configuration, anchor devices may be allowed to operate in different areas based on the area ID, a list of camped cells, the zone ID, a PLMN ID, or any other type of geographical region identifier. In another implementation, the anchor device may dynamically update its known location and antenna orientation information based on the applicable mobility. Dynamic location and antenna orientation updates may include 2D/3D location information, including latitude and longitudinal information, antenna locations, distributed antenna (DAS) locations, device antenna panel information, or the like. The location updates may be event triggered based on delta locations compared to the previously reported locations. In other implementation, the anchor device may report the relative timing difference between its SL PRS transmission and other (candidate) anchor devices.

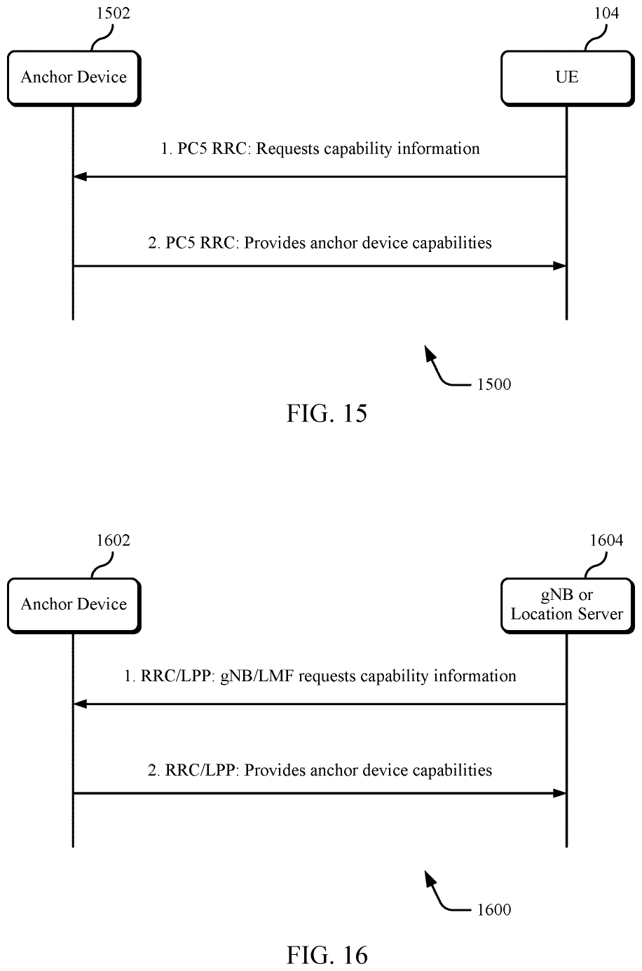

FIG. 15 illustrates an example 1500 of anchor device capability exchange that supports sidelink anchor device management in accordance with aspects of the present disclosure. This example 1500 illustrates a solicited request for anchor device capability information of an anchor device 1502 from a UE 104 via SL (PC5) interface. The anchor device 1502 can provide its capability information indicating an ability to operate as an anchor device via solicited and/or unsolicited signaling to other UEs via the SL (PC5) interface. In another implementation, a dedicated sidelink positioning protocol may be used to signal anchor device capability information. In an extended implementation, the capabilities may also apply to the initiator and/or responder devices participating in a sidelink session. Similarly, FIG. 16 illustrates an example 1600 of anchor device capability exchange that supports sidelink anchor device management in accordance with aspects of the present disclosure. This example 1600 illustrates a solicited request for anchor device capability information of an anchor device 1602 from a gNB or location server 1604 via Uu interface using RRC or LPP signaling. The anchor device 1602 can provide its capability information indicating an ability to operate as an anchor device via solicited and/or unsolicited signaling to network entities, such as to the gNB (e.g., using RRC signaling) and/or to the LMF (e.g., using LPP signaling).

In aspects of these two types of capability exchange for anchor devices, the anchor device capabilities can include the following described features. Supported sidelink positioning methods, e.g., SL-TDoA, SL-RTT (single-sided and/or double-sided), SL-AoA, etc. Supported hybrid positioning modes including one or more of the above sidelink positioning and/or Uu positioning techniques. The maximum number of PRS resources the anchor device may transmit, which may be according to defined SL PRS resource granularities including sidelink positioning frequency layer, SL PRS Resource Pool, SL PRS Resource Set, SL PRS Resource IDs. Supported positioning modes of the anchor device as detailed above with reference to the identification, selection, and configuration of a sidelink anchor device, including UE-based UE-configured, UE-based network-configured, UE-assisted UE-configured, and UE-assisted network-configured. Supported measurement capabilities, including a list of supported bands including FR1 and FR2. Supported PRS processing capabilities (if applicable), and reporting modes including periodical, semi-persistent, and one-shot reporting. Capable of jointly acting as an anchor device for Uu and sidelink positioning methods. Supported number of per pair of sidelink RSTD measurements if the anchor device is performing measurements. The mobility type of the anchor device as static or mobile. The location source as RAT-dependent or RAT-independent methods, pre-configured, offline, and/or calibration. The anchor device type as a UE, a RSU, a CPE, and the like. An anchor device ID may also be signaled as part of the capability message. An indication that the device may operate in-coverage, out-of-coverage and/or in partial coverage scenarios.

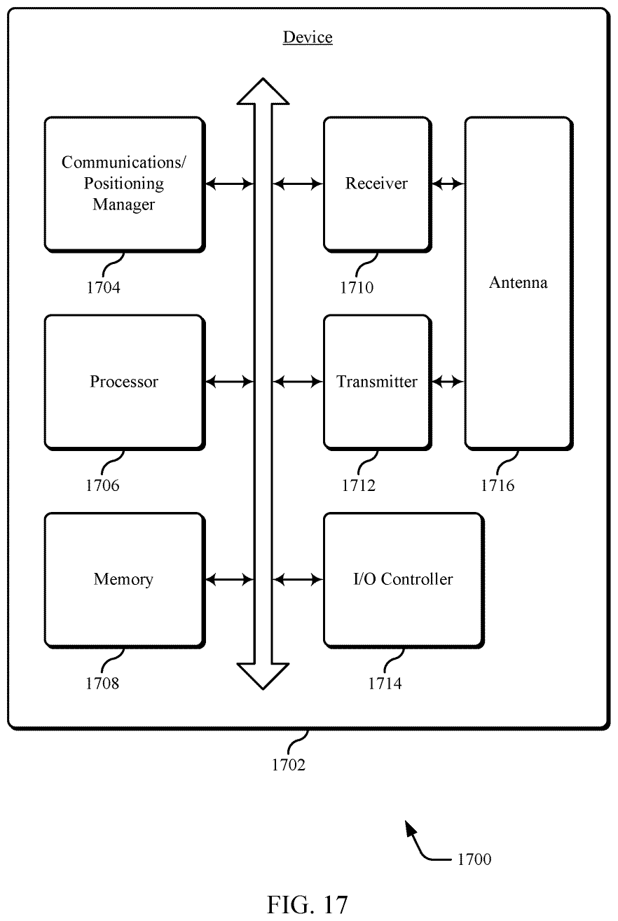

FIG. 17 illustrates an example of a block diagram 1700 of a device 1702 that supports sidelink positioning reference unit management in accordance with aspects of the present disclosure. The device 1702 may be an example of a SL PRU 116 (e.g., a UE 104 or other device) as described herein. Additionally or alternatively, the device 1702 may be an example of a configuration entity, such as a UE, an anchor UE, a base station, a gNB, a roadside unit, a location server, or other type of configuration entity as described herein. The device 1702 may support wireless communication and/or network signaling with one or more base stations 102, other UEs 104, network entities and devices, or any combination thereof. The device 1702 may include components for bi-directional communications including components for transmitting and receiving communications, such as a communications and/or positioning manager 1704, a processor 1706, a memory 1708, a receiver 1710, a transmitter 1712, and an I/O controller 1714. These components may be in electronic communication or otherwise coupled (e.g., operatively, communicatively, functionally, electronically, electrically) via one or more interfaces (e.g., buses).

The communications and/or positioning manager 1704, the receiver 1710, the transmitter 1712, or various combinations thereof or various components thereof may be examples of means for performing various aspects of the present disclosure as described herein. For example, the communications and/or positioning manager 1704, the receiver 1710, the transmitter 1712, or various combinations or components thereof may support a method for performing one or more of the functions described herein.

In some implementations, the and/or positioning communications manager 1704, the receiver 1710, the transmitter 1712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1706 and the memory 1708 coupled with the processor 1706 may be configured to perform one or more of the functions described herein (e.g., by executing, by the processor 1706, instructions stored in the memory 1708).

Additionally or alternatively, in some implementations, the communications and/or positioning manager 1704, the receiver 1710, the transmitter 1712, or various combinations or components thereof may be implemented in code (e.g., as communications management software or firmware) executed by the processor 1706. If implemented in code executed by the processor 1706, the functions of the communications and/or positioning manager 1704, the receiver 1710, the transmitter 1712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications and/or positioning manager 1704 may be configured to perform various operations (e.g., receiving, monitoring, transmitting) using or otherwise in cooperation with the receiver 1710, the transmitter 1712, or both. For example, the communications and/or positioning manager 1704 may receive information from the receiver 1710, send information to the transmitter 1712, or be integrated in combination with the receiver 1710, the transmitter 1712, or both to receive information, transmit information, or perform various other operations as described herein. Although the communications and/or positioning manager 1704 is illustrated as a separate component, in some implementations, one or more functions described with reference to the communications and/or positioning manager 1704 may be supported by or performed by the processor 1706, the memory 1708, or any combination thereof. For example, the memory 1708 may store code, which may include instructions executable by the processor 1706 to cause the device 1702 to perform various aspects of the present disclosure as described herein, or the processor 1706 and the memory 1708 may be otherwise configured to perform or support such operations.

For example, the communications manager 1704 may support wireless communication and/or network signaling at a device (e.g., the device 1702, a SL PRU 116 such as a UE 104) in accordance with examples as disclosed herein. The communications manager 1704 and/or other device components may be configured as or otherwise support an apparatus, such as a UE, including a transceiver; a processor coupled to the transceiver, the processor and the transceiver configured to cause the apparatus to: receive, from a configuration entity, a measurement configuration to perform sidelink positioning reference measurements; collect one or more sidelink positioning reference measurements; and transmit, to the configuration entity, the one or more sidelink positioning reference measurements and a known location of the apparatus.

Additionally, the apparatus (e.g., a SL PRU) includes any one or combination of: where the one or more sidelink positioning reference measurements include at least one of a timing-based reference measurement or an angular-based reference measurement; where the one or more sidelink positioning reference measurements include at least one of a SL-RSTD reference measurement, a SL UE Rx-Tx time difference reference measurement, a SL ToF reference measurement, a ToA reference measurement, a SL-angle-of-arrival measurement, a SL TDoA reference measurement, a SL RTT reference measurement, or a SL AoA reference measurement; where the known location of the apparatus includes one or more of 2D or 3D latitude and longitude information, height or altitude information, a velocity estimate, an antenna and panel related location information and reference points, or an uncertainty value or a confidence interval associated with the known location; where the configuration entity comprises a UE, and where the processor and the transceiver are further configured to cause the apparatus to: receive, from the UE, a request for the one or more sidelink positioning reference measurements and the known location of the apparatus; and transmit, to the UE in response to the request, the one or more sidelink positioning reference measurements and a known location of the apparatus; where the configuration entity comprises a network entity, and where the processor and the transceiver are further configured to cause the apparatus to: receive, from the network entity, a request for the one or more sidelink positioning reference measurements and the known location of the apparatus; and transmit, to the network entity in response to the request, the one or more sidelink positioning reference measurements and a known location of the apparatus; where the apparatus comprises a UE, and where the processor and the transceiver are further configured to cause the apparatus to operate in at least one of a UE-based UE-configured positioning mode, a UE-based network-configured positioning mode, a UE-assisted UE-configured positioning mode, or a UE-assisted network-configured positioning mode; where the processor and the transceiver are further configured to cause the apparatus to collect the one or more sidelink positioning reference measurements in a FR1 band or a FR2 band; where the processor and the transceiver are further configured to cause the apparatus to: collect one or more NR Uu interface positioning reference measurements; and transmit, to a base station, the one or more NR Uu positioning reference measurements and the known location of the apparatus; where the apparatus includes an ID that is at least one of a L1-ID derived from a L2-ID, a self-generated ID, or an application ID generated by a sidelink positioning application of the apparatus, and where the processor and the transceiver are further configured to cause the apparatus to: transmit, to the configuration entity, the apparatus ID with the one or more sidelink positioning reference measurements and the known location of the apparatus; where the processor and the transceiver are further configured to cause the apparatus to: receive, from a UE, a request for capability information regarding the apparatus acting as a sidelink positioning reference unit; and transmit, to the UE in response to the request, capability information regarding the apparatus acting as a sidelink positioning reference unit; where the processor and the transceiver are further configured to cause the apparatus to: receive, from a network entity, a request for capability information regarding the apparatus acting as a sidelink positioning reference unit; and transmit, to the network entity in response to the request, capability information regarding the apparatus acting as a sidelink positioning reference unit; where the processor and the transceiver are further configured to cause the apparatus to: dynamically update the known location and antenna orientation information of the apparatus, where the updated known location and antenna orientation information is based at least in part on delta locations compared to one or more previously reported locations.

The communications manager 1704 and/or other device components may be configured as or otherwise support a means for wireless communication and/or network signaling at a SL PRU, including receiving, from a configuration entity, a measurement configuration to perform sidelink positioning reference measurements; collecting one or more sidelink positioning reference measurements; and transmitting, to the configuration entity, the one or more sidelink positioning reference measurements and a known location of the PRU.

Additionally, wireless communication and/or network signaling at the SL PRU includes any one or combination of: where the one or more sidelink positioning reference measurements include at least one of a timing-based reference measurement or an angular-based reference measurement; the one or more sidelink positioning reference measurements include at least one of a SL-RSTD reference measurement, a SL UE Rx-Tx time difference reference measurement, a SL ToF reference measurement, a ToA reference measurement, a SL-angle-of-arrival measurement, a SL TDoA reference measurement, a SL RTT reference measurement, or a SL AoA reference measurement; where the known location of the PRU includes one or more of 2D or 3D latitude and longitude information, height or altitude information, a velocity estimate, an antenna and panel related location information and reference points, or an uncertainty value or a confidence interval associated with the known location; where the configuration entity comprises a UE, and further comprises: receiving, from the UE, a request for the one or more sidelink positioning reference measurements and the known location of the PRU; and transmitting, to the UE in response to the request, the one or more sidelink positioning reference measurements and a known location of the PRU; where the configuration entity comprises a network entity, and further comprises: receiving, from the network entity, a request for the one or more sidelink positioning reference measurements and the known location of the PRU; and transmitting, to the network entity in response to the request, the one or more sidelink positioning reference measurements and a known location of the PRU; where the PRU comprises a UE, and further comprises operating in at least one of a UE-based UE-configured positioning mode, a UE-based network-configured positioning mode, a UE-assisted UE-configured positioning mode, or a UE-assisted network-configured positioning mode; further including collecting the one or more sidelink positioning reference measurements in a FR1 band or a FR2 band; further including: collecting one or more NR Uu interface positioning reference measurements; and transmitting, to a base station, the one or more NR Uu positioning reference measurements and the known location of the PRU; where the PRU includes a PRU ID that is at least one of a L1-IDderived from a L2-ID, a self-generated ID, or an application ID generated by a sidelink positioning application of the PRU, and the method further comprises: transmitting, to the configuration entity, the PRU ID with the one or more sidelink positioning reference measurements and the known location of the PRU; further including: receiving, from a UE, a request for capability information regarding the PRU acting as a sidelink positioning reference unit; and transmitting, to the UE in response to the request, capability information regarding the PRU acting as a sidelink positioning reference unit; further including: receiving, from a network entity, a request for capability information regarding the PRU acting as a sidelink positioning reference unit; and transmitting, to the network entity in response to the request, capability information regarding the PRU acting as a sidelink positioning reference unit; further including: dynamically update the known location and antenna orientation information of an apparatus implementing the method, where the updated known location and antenna orientation information is based at least in part on delta locations compared to one or more previously reported locations.

For example, the positioning manager 1704 may support wireless communication and/or network signaling at a device (e.g., the device 1702, a configuration entity) in accordance with examples as disclosed herein. The positioning manager 1704 and/or other device components may be configured as or otherwise support an apparatus, such as a device implemented as a configuration entity, including a transceiver; a processor coupled to the transceiver, the processor and the transceiver configured to cause the apparatus to: transmit a sidelink positioning capability request to one or more sidelink devices as potential sidelink anchor devices; receive, from the one or more sidelink devices, anchor device capability information and a location of the respective one or more sidelink devices; select at least one of the one or more sidelink devices as an anchor device based at least in part on the anchor device capability information and the location of the at least one sidelink device; and transmit a sidelink positioning reference signal transmission configuration to the anchor device establishing a sidelink positioning session with a target device.

Additionally, the apparatus (e.g., a device implemented as a configuration entity) includes any one or combination of: the location of the at least one sidelink device is designated as a fixed location in time. The processor is configured to cause the apparatus to select the at least one sidelink device as the anchor device based at least in part on a sidelink line-of-sight link quality between the apparatus and the at least one sidelink device. The processor is configured to cause the apparatus to select the at least one sidelink device as the anchor device based at least in part on a sidelink communication range of the at least one sidelink device to the apparatus. The processor is configured to cause the apparatus to select the at least one sidelink device as the anchor device based at least in part on a sidelink measurement quality. The processor and the transceiver are configured to cause the apparatus to receive, from the at least one sidelink device, one or more sidelink measurements and the location of the at least one sidelink device; and select the at least one sidelink device as the anchor device based at least in part on the one or more sidelink measurements and the location. The apparatus comprises at least one of a user equipment (UE), an anchor UE, a base station, a next-generation NodeB (gNB), a roadside unit, or a location server. The processor and the transceiver are configured to cause the apparatus to receive, from a network device, a candidate list of the potential sidelink anchor devices. The processor is configured to cause the apparatus to select the anchor device based at least in part on a link quality between each of the potential sidelink anchor devices. The processor is configured to cause the apparatus to select the anchor device based at least in part on a coverage area of each of the potential sidelink anchor devices. The apparatus comprises a user equipment (UE), and wherein the processor is configured to cause the apparatus to configure the anchor device according to at least one of a UE-based UE-configured anchor device configuration, a UE-based network-configured anchor device configuration, a UE-assisted UE-configured anchor device configuration, or a UE-assisted network-configured anchor device configuration. The processor and the transceiver are configured to cause the apparatus to receive, from the anchor device, a status indication as one of the anchor device is operably configured as the anchor device or is no longer operable as the anchor device.

The positioning manager 1704 and/or other device components may be configured as or otherwise support a means for wireless communication and/or network signaling at a device, including transmitting a sidelink positioning capability request to one or more sidelink devices as potential sidelink anchor devices; receiving, from the one or more sidelink devices, anchor device capability information and a location of the respective one or more sidelink devices; selecting at least one of the one or more sidelink devices as an anchor device based at least in part on the anchor device capability information and the location of the at least one sidelink device; and transmitting a sidelink positioning reference signal transmission configuration to the anchor device establishing a sidelink positioning session with a target device.

Additionally, wireless communication and/or network signaling at the device includes any one or combination of: the location of the at least one sidelink device is designated as a fixed location in time. The selecting the at least one sidelink device as the anchor device is based at least in part on a sidelink line-of-sight link quality between a configuration entity and the at least one sidelink device. The selecting the at least one sidelink device as the anchor device is based at least in part on a sidelink communication range of the at least one sidelink device to a configuration entity. The selecting the at least one sidelink device as the anchor device is based at least in part on a sidelink measurement quality. The method further comprising receiving, from the at least one sidelink device, one or more sidelink measurements and the location of the at least one sidelink device, and wherein the selecting the at least one sidelink device as the anchor device is based at least in part on the one or more sidelink measurements and the location. A configuration entity comprises at least one of a user equipment (UE), an anchor UE, a base station, a next-generation NodeB (gNB), a roadside unit, or a location server. The method further comprising receiving, from a network device, a candidate list of the potential sidelink anchor devices. The selecting the anchor device is based at least in part on a link quality between each of the potential sidelink anchor devices. The selecting the anchor device is based at least in part on a coverage area of each of the potential sidelink anchor devices. The anchor device is configured according to at least one of a UE-based UE-configured anchor device configuration, a UE-based network-configured anchor device configuration, a UE-assisted UE-configured anchor device configuration, or a UE-assisted network-configured anchor device configuration. The method further comprising receiving, from the anchor device, a status indication as one of the anchor device is operably configured as the anchor device or is no longer operable as the anchor device.

The processor 1706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1706 may be configured to operate a memory array using a memory controller. In some other implementations, a memory controller may be integrated into the processor 1706. The processor 1706 may be configured to execute computer-readable instructions stored in a memory (e.g., the memory 1708) to cause the device 1702 to perform various functions of the present disclosure.

The memory 1708 may include random access memory (RAM) and read-only memory (ROM). The memory 1708 may store computer-readable, computer-executable code including instructions that, when executed by the processor 1706 cause the device 1702 to perform various functions described herein. The code may be stored in a non-transitory computer-readable medium such as system memory or another type of memory. In some implementations, the code may not be directly executable by the processor 1706 but may cause a computer (e.g., when compiled and executed) to perform functions described herein. In some implementations, the memory 1708 may include, among other things, a basic I/O system (BIOS) which may control basic hardware or software operation such as the interaction with peripheral components or devices.

The I/O controller 1714 may manage input and output signals for the device 1702. The I/O controller 1714 may also manage peripherals not integrated into the device 1702. In some implementations, the I/O controller 1714 may represent a physical connection or port to an external peripheral. In some implementations, the I/O controller 1714 may utilize an operating system such as iOS®, ANDROID®, MS-DOS®, MS-WINDOWS®, OS/2®, UNIX®, LINUX®, or another known operating system. In some implementations, the I/O controller 1714 may be implemented as part of a processor, such as the processor 1706. In some implementations, a user may interact with the device 1702 via the I/O controller 1714 or via hardware components controlled by the I/O controller 1714.

In some implementations, the device 1702 may include a single antenna 1716. However, in some other implementations, the device 1702 may have more than one antenna 1716, which may be capable of concurrently transmitting or receiving multiple wireless transmissions. The receiver 1710 and the transmitter 1712 may communicate bi-directionally, via the one or more antennas 1716, wired, or wireless links as described herein. For example, the receiver 1710 and the transmitter 1712 may represent a wireless transceiver and may communicate bi-directionally with another wireless transceiver. The transceiver may also include a modem to modulate the packets, to provide the modulated packets to one or more antennas 1716 for transmission, and to demodulate packets received from the one or more antennas 1716.

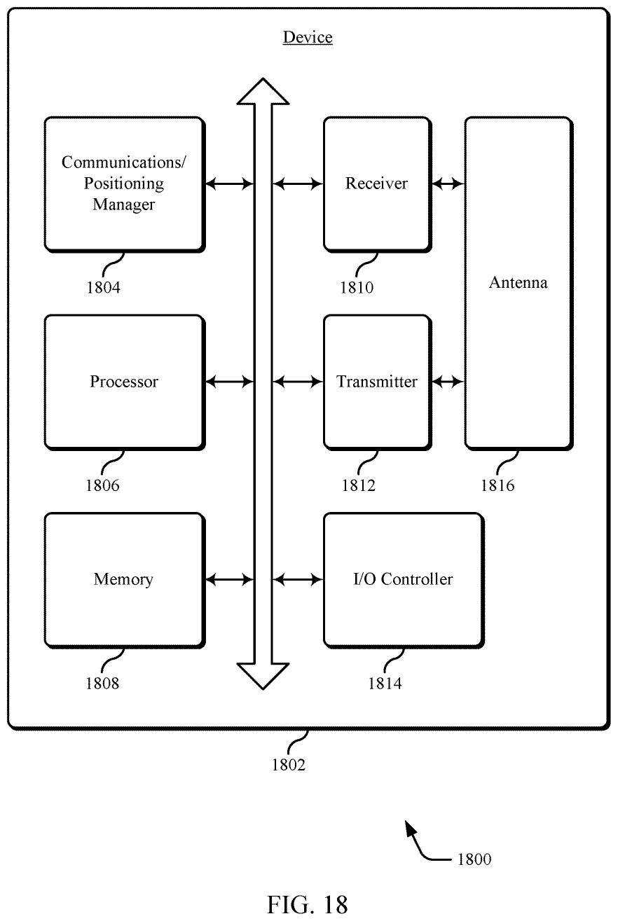

FIG. 18 illustrates an example of a block diagram 1800 of a device 1802 that supports sidelink positioning reference unit management in accordance with aspects of the present disclosure. The device 1802 may be an example of a configuration entity or a positioning calculation entity, as described herein. The device 1802 may support wireless communication and/or network signaling with one or more base stations 102, other UEs 104, core network devices and functions (e.g., core network 106), or any combination thereof. The device 1802 may include components for bi-directional communications including components for transmitting and receiving communications, such as a communications and/or positioning manager 1804, a processor 1806, a memory 1808, a receiver 1810, a transmitter 1812, and an I/O controller 1814. These components may be in electronic communication or otherwise coupled (e.g., operatively, communicatively, functionally, electronically, electrically) via one or more interfaces (e.g., buses).

The communications and/or positioning manager 1804, the receiver 1810, the transmitter 1812, or various combinations thereof or various components thereof may be examples of means for performing various aspects of the present disclosure as described herein. For example, the communications and/or positioning manager 1804, the receiver 1810, the transmitter 1812, or various combinations or components thereof may support a method for performing one or more of the functions described herein.

In some implementations, the communications and/or positioning manager 1804, the receiver 1810, the transmitter 1812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1806 and the memory 1808 coupled with the processor 1806 may be configured to perform one or more of the functions described herein (e.g., by executing, by the processor 1806, instructions stored in the memory 1808).

Additionally or alternatively, in some implementations, the communications and/or positioning manager 1804, the receiver 1810, the transmitter 1812, or various combinations or components thereof may be implemented in code (e.g., as communications management software or firmware) executed by the processor 1806. If implemented in code executed by the processor 1806, the functions of the communications and/or positioning manager 1804, the receiver 1810, the transmitter 1812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications and/or positioning manager 1804 may be configured to perform various operations (e.g., receiving, monitoring, transmitting) using or otherwise in cooperation with the receiver 1810, the transmitter 1812, or both. For example, the communications and/or positioning manager 1804 may receive information from the receiver 1810, send information to the transmitter 1812, or be integrated in combination with the receiver 1810, the transmitter 1812, or both to receive information, transmit information, or perform various other operations as described herein. Although the communications and/or positioning manager 1804 is illustrated as a separate component, in some implementations, one or more functions described with reference to the communications and/or positioning manager 1804 may be supported by or performed by the processor 1806, the memory 1808, or any combination thereof. For example, the memory 1808 may store code, which may include instructions executable by the processor 1806 to cause the device 1802 to perform various aspects of the present disclosure as described herein, or the processor 1806 and the memory 1808 may be otherwise configured to perform or support such operations.

For example, the communications manager 1804 may support wireless communication and/or network signaling at a device (e.g., the device 1802, such as a configuration entity or a positioning calculation entity) in accordance with examples as disclosed herein. The communications manager 1804 and/or other device components may be configured as or otherwise support an apparatus, such as a configuration entity or a positioning calculation entity, including a transceiver; a processor coupled to the transceiver, the processor and the transceiver configured to cause the apparatus to: receive, from a PRU, one or more sidelink positioning reference measurements and a known location of the PRU; generate measurement error correction information based at least in part on the one or more sidelink positioning reference measurements; and transmit, to a positioning calculation entity, the measurement error correction information.

Additionally, the apparatus (e.g., a configuration entity or a positioning calculation entity) includes any one or combination of: where the processor and the transceiver are further configured to cause the apparatus to: generate the measurement error correction information by determining a calibration of timing-based and angular-based measurement errors based at least in part on the on the one or more sidelink positioning reference measurements; and transmit, to the PRU as the measurement error correction information, the timing-based and angular-based measurement error correction information; where the measurement error correction information includes at least one of pseudo-range errors, synchronization timing errors, RSTD reference measurements, AOA calibration errors, or time validity duration of the measurement error correction information; where the processor and the transceiver are further configured to cause the apparatus to: transmit, to the PRU, a measurement configuration for the PRU to perform sidelink positioning reference measurements using the one or more sidelink positioning reference measurements; and receive, in response to the measurement configuration, the one or more sidelink positioning reference measurements and the known location of the PRU; where the apparatus is the positioning calculation entity; where the one or more sidelink positioning reference measurements include at least one of a timing-based reference measurement or an angular-based reference measurement; where the one or more sidelink positioning reference measurements include at least one of a SL-RSTD reference measurement, a SL UE Rx-Tx time difference reference measurement, a SL ToF reference measurement, a ToA reference measurement, a SL-angle-of-arrival measurement, a SL TDoA reference measurement, a SL RTT reference measurement, or a SL AoA reference measurement; where the known location of the PRU includes one or more of 2D or 3D latitude and longitude information, height or altitude information, a velocity estimate, an antenna and panel related location information and reference points, or an uncertainty value or a confidence interval associated with the known location; where the apparatus comprises a UE, and where the processor and the transceiver are further configured to cause the apparatus to: transmit, to the PRU, a request for the one or more sidelink positioning reference measurements and the known location of the PRU; and receive, from the PRU in response to the request, the one or more sidelink positioning reference measurements and a known location of the PRU; where the apparatus comprises a network entity, and where the processor and the transceiver are further configured to cause the apparatus to: transmit, to the PRU, a request for the one or more sidelink positioning reference measurements and the known location of the PRU; and receive, from the PRU in response to the request, the one or more sidelink positioning reference measurements and a known location of the PRU; where the PRU includes a PRU ID that is at least one of a L1-ID derived from a L2-ID, a self-generated ID, or an application ID generated by a sidelink positioning application of the PRU, and where the processor and the transceiver are further configured to cause the apparatus to: receive, from the PRU, the PRU ID with the one or more sidelink positioning reference measurements and the known location of the PRU; where the processor and the transceiver are further configured to cause the apparatus to: transmit, to the PRU, a request for capability information regarding the PRU acting as a sidelink positioning reference unit; and receive, from the PRU in response to the request, capability information regarding the PRU acting as a sidelink positioning reference unit.

The communications manager 1804 and/or other device components may be configured as or otherwise support a means for wireless communication and/or network signaling at a configuration entity or a positioning calculation entity, including receiving, from a positioning reference unit PRU, one or more sidelink positioning reference measurements and a known location of the PRU; generating measurement error correction information based at least in part on the one or more sidelink positioning reference measurements; and transmitting, to a positioning calculation entity, the measurement error correction information.

Additionally, wireless communication at the configuration entity or a positioning calculation entity includes any one or combination of: further including: generating the measurement error correction information by determining a calibration of timing-based and angular-based measurement errors based at least in part on the on the one or more sidelink positioning reference measurements; and transmitting, to the PRU as the measurement error correction information, the timing-based and angular-based measurement error correction information; where the measurement error correction information includes at least one of pseudo-range errors, synchronization timing errors, RSTD reference measurements, AOA calibration errors, or time validity duration of the measurement error correction information; further including: transmitting, to the PRU, a measurement configuration for the PRU to perform sidelink positioning reference measurements using the one or more sidelink positioning reference measurements; and receiving, in response to the measurement configuration, the one or more sidelink positioning reference measurements and the known location of the PRU; where the method is implemented in the positioning calculation entity; where the one or more sidelink positioning reference measurements include at least one of a timing-based reference measurement or an angular-based reference measurement; where the one or more sidelink positioning reference measurements include at least one of a SL-RSTD reference measurement, a SL UE Rx-Tx time difference reference measurement, a SL ToF reference measurement, a ToA reference measurement, a SL-angle-of-arrival measurement, a SL TDoA reference measurement, a SL RTT reference measurement, or a SL AoA reference measurement; where the known location of the PRU includes one or more of 2D or 3D latitude and longitude information, height or altitude information, a velocity estimate, an antenna and panel related location information and reference points, or an uncertainty value or a confidence interval associated with the known location; where the method is implemented in a UE, and further comprises: transmitting, to the PRU, a request for the one or more sidelink positioning reference measurements and the known location of the PRU; and receiving, from the PRU in response to the request, the one or more sidelink positioning reference measurements and a known location of the PRU; where the method is implemented in a network entity, and further comprises: transmitting, to the PRU, a request for the one or more sidelink positioning reference measurements and the known location of the PRU; and receiving, from the PRU in response to the request, the one or more sidelink positioning reference measurements and a known location of the PRU; where the PRU includes a PRU ID that is at least one of a L1-ID derived from a L2-ID, a self-generated ID, or an application ID generated by a sidelink positioning application of the PRU, and where the method further comprises: receiving, from the PRU, the PRU ID with the one or more sidelink positioning reference measurements and the known location of the PRU; further including: transmitting, to the PRU, a request for capability information regarding the PRU acting as a sidelink positioning reference unit; and receiving, from the PRU in response to the request, capability information regarding the PRU acting as a sidelink positioning reference unit.

For example, the positioning manager 1804 may support wireless communication and/or network signaling at a device (e.g., the device 1802, an anchor device) in accordance with examples as disclosed herein. The positioning manager 1804 and/or other device components may be configured as or otherwise support an apparatus, such as an anchor device, including a transceiver; a processor coupled to the transceiver, the processor and the transceiver configured to cause the apparatus to: receive, from a configuration device, a sidelink positioning capability request; transmit, to the configuration device, anchor device capability information and a location of the apparatus; and receive, as a selected anchor device based at least in part on the anchor device capability information and the location of the apparatus, a sidelink positioning reference signal transmission configuration establishing a sidelink positioning session with one or more target devices.

Additionally, the apparatus (e.g., an anchor device) includes any one or combination of: the location of the apparatus is designated as a fixed location in time. The apparatus is selected as the anchor device based at least in part on a sidelink line-of-sight link quality between the apparatus and the one or more target devices. The apparatus is selected as the anchor device based at least in part on a sidelink communication range of the apparatus to the one or more target devices. The apparatus is selected as the anchor device based at least in part on a sidelink measurement quality. The processor and the transceiver are configured to cause the apparatus to transmit a sidelink positioning reference signal to the one or more target devices based at least in part on the location of the apparatus and mobility of the apparatus. The processor is configured to cause the apparatus to determine a location estimation of the configuration device. The processor and the transceiver are configured to cause the apparatus to transmit sidelink positioning configuration information to the one or more target devices participating in the sidelink positioning session. The processor and the transceiver are configured to cause the apparatus to transmit the anchor device capability information and the location of the apparatus to the one or more target devices participating in the sidelink positioning session. The processor and the transceiver are configured to cause the apparatus to transmit pre-defined assistance information to the one or more target devices participating in the sidelink positioning session. The processor and the transceiver are configured to cause the apparatus to transmit, to the configuration device, a status indication as one of the apparatus is operably configured as the anchor device or is no longer operable as the anchor device. The apparatus is the anchor device configured according to at least one of a UE-based UE-configured anchor device configuration, a UE-based network-configured anchor device configuration, a UE-assisted UE-configured anchor device configuration, or a UE-assisted network-configured anchor device configuration. The apparatus includes an anchor device identifier (ID) that is at least one of a layer one ID (L1-ID) derived from a layer two ID (L2-ID), a self-generated ID, or an application ID generated by a sidelink positioning application of the apparatus, and wherein the processor and the transceiver are further configured to cause the apparatus to transmit, to the configuration device, the anchor device ID with the anchor device capability information and the location of the apparatus. The processor and the transceiver are configured to cause the apparatus to transmit time difference information with respect to itself and one or more additional anchor devices.

The positioning manager 1804 and/or other device components may be configured as or otherwise support a means for wireless communication and/or network signaling at an anchor device, including receiving, from a configuration device, a sidelink positioning capability request; transmitting, to the configuration device, anchor device capability information and a location; and receiving, as a selected anchor device based at least in part on the anchor device capability information and the location, a sidelink positioning reference signal transmission configuration establishing a sidelink positioning session with one or more target devices.

Additionally, wireless communication at the anchor device includes any one or combination of: the location is designated as a fixed location in time. The anchor device is selected based at least in part on a sidelink line-of-sight link quality between the anchor device and the one or more target devices. The anchor device is selected based at least in part on a sidelink communication range of the anchor device to the one or more target devices. The anchor device is selected based at least in part on a sidelink measurement quality. The method further comprising transmitting a sidelink positioning reference signal to the one or more target devices based at least in part on the location and mobility of the anchor device. The method further comprising determining a location estimation of the configuration device. The method further comprising transmitting sidelink positioning configuration information to the one or more target devices participating in the sidelink positioning session. The method further comprising transmitting the anchor device capability information and the location to the one or more target devices participating in the sidelink positioning session. The method further comprising transmitting pre-defined assistance information to the one or more target devices participating in the sidelink positioning session. The method further comprising transmitting, to the configuration device, a status indication as one of the anchor device being operably configured as the anchor device or is no longer operable as the anchor device. The anchor device is configured according to at least one of a UE-based UE-configured anchor device configuration, a UE-based network-configured anchor device configuration, a UE-assisted UE-configured anchor device configuration, or a UE-assisted network-configured anchor device configuration. The anchor device includes an anchor device identifier (ID) that is at least one of a layer one ID (L1-ID) derived from a layer two ID (L2-ID), a self-generated ID, or an application ID generated by a sidelink positioning application of the apparatus, and wherein the anchor device ID is transmitted to the configuration device with the anchor device capability information and the location. The method further comprising transmitting, by the anchor device, time difference information with respect to itself and one or more additional anchor devices.

The processor 1806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1806 may be configured to operate a memory array using a memory controller. In some other implementations, a memory controller may be integrated into the processor 1806. The processor 1806 may be configured to execute computer-readable instructions stored in a memory (e.g., the memory 1808) to cause the device 1802 to perform various functions of the present disclosure.

The memory 1808 may include random access memory (RAM) and read-only memory (ROM). The memory 1808 may store computer-readable, computer-executable code including instructions that, when executed by the processor 1806 cause the device 1802 to perform various functions described herein. The code may be stored in a non-transitory computer-readable medium such as system memory or another type of memory. In some implementations, the code may not be directly executable by the processor 1806 but may cause a computer (e.g., when compiled and executed) to perform functions described herein. In some implementations, the memory 1808 may include, among other things, a basic I/O system (BIOS) which may control basic hardware or software operation such as the interaction with peripheral components or devices.

The I/O controller 1814 may manage input and output signals for the device 1802. The I/O controller 1814 may also manage peripherals not integrated into the device 1802. In some implementations, the I/O controller 1814 may represent a physical connection or port to an external peripheral. In some implementations, the I/O controller 1814 may utilize an operating system such as iOS®, ANDROID®, MS-DOS®, MS-WINDOWS®, OS/2®, UNIX®, LINUX®, or another known operating system. In some implementations, the I/O controller 1814 may be implemented as part of a processor, such as the processor 1806. In some implementations, a user may interact with the device 1802 via the I/O controller 1814 or via hardware components controlled by the I/O controller 1814.

In some implementations, the device 1802 may include a single antenna 1816. However, in some other implementations, the device 1802 may have more than one antenna 1816, which may be capable of concurrently transmitting or receiving multiple wireless transmissions. The receiver 1810 and the transmitter 1812 may communicate bi-directionally, via the one or more antennas 1816, wired, or wireless links as described herein. For example, the receiver 1810 and the transmitter 1812 may represent a wireless transceiver and may communicate bi-directionally with another wireless transceiver. The transceiver may also include a modem to modulate the packets, to provide the modulated packets to one or more antennas 1816 for transmission, and to demodulate packets received from the one or more antennas 1816.

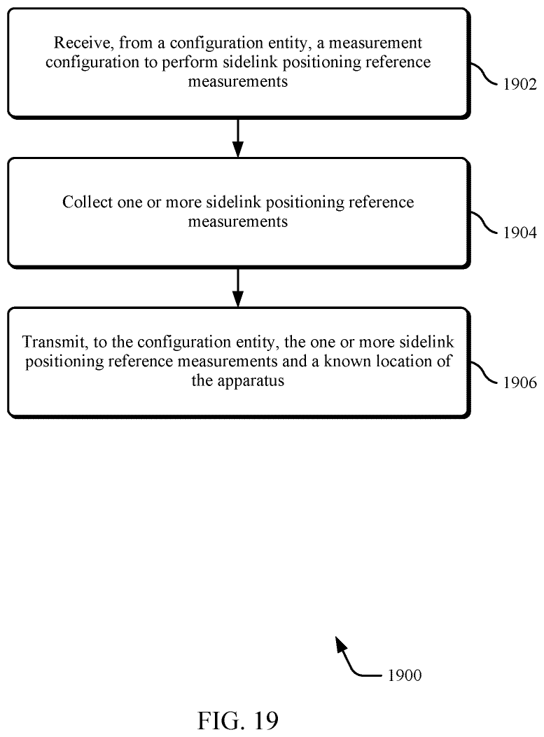

FIG. 19 illustrates a flowchart of a method 1900 that supports sidelink positioning reference unit management in accordance with aspects of the present disclosure. The operations of the method 1900 may be implemented and performed by a device or its components, such as a SL PRU 116 as described with reference to FIGS. 1 through 18. In some implementations, the device may execute a set of instructions to control the function elements of the device to perform the described functions. Additionally, or alternatively, the device may perform aspects of the described functions using special-purpose hardware. Z

At 1902, the method may include receiving, from a configuration entity, a measurement configuration to perform sidelink positioning reference measurements. The operations of 1902 may be performed in accordance with examples as described herein. In some implementations, aspects of the operations of 1902 may be performed by a device as described with reference to FIG. 1.

At 1904, the method may include collecting one or more sidelink positioning reference measurements. The operations of 1904 may be performed in accordance with examples as described herein. In some implementations, aspects of the operations of 1904 may be performed by a device as described with reference to FIG. 1.

At 1906, the method may include transmitting, to the configuration entity, the one or more sidelink positioning reference measurements and a known location of the apparatus. The operations of 1906 may be performed in accordance with examples as described herein. In some implementations, aspects of the operations of 1906 may be performed by a device as described with reference to FIG. 1.

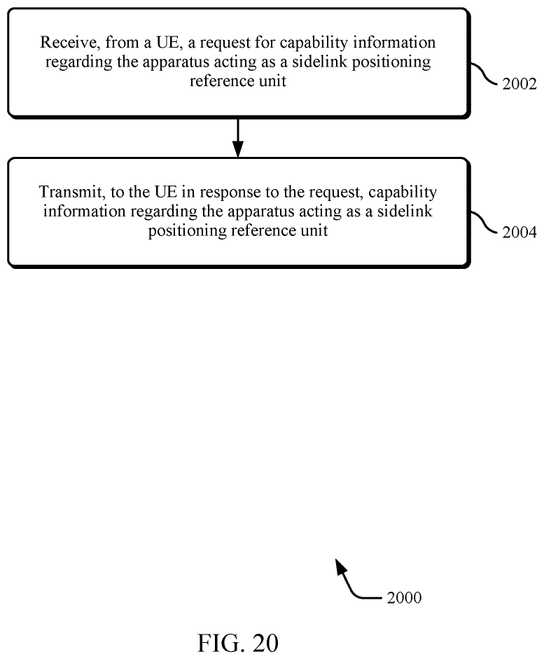

FIG. 20 illustrates a flowchart of a method 2000 that supports sidelink positioning reference unit management in accordance with aspects of the present disclosure. The operations of the method 2000 may be implemented and performed by a device or its components, such as a SL PRU 116 as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2002, the method may include receiving, from a UE, a request for capability information regarding the apparatus acting as a sidelink positioning reference unit. The operations of 2002 may be performed in accordance with examples as described herein. In some implementations, aspects of the operations of 2002 may be performed by a device as described with reference to FIG. 1.

At 2004, the method may include transmitting, to the UE in response to the request, capability information regarding the apparatus acting as a sidelink positioning reference unit. The operations of 2004 may be performed in accordance with examples as described herein. In some implementations, aspects of the operations of 2004 may be performed by a device as described with reference to FIG. 1.

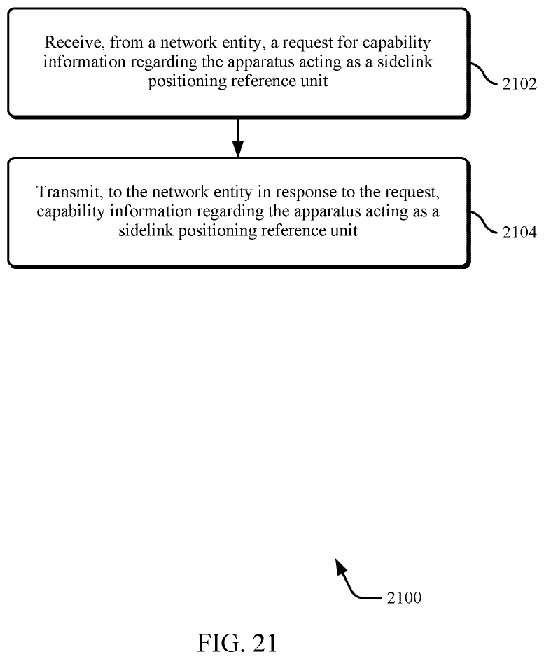

FIG. 21 illustrates a flowchart of a method 2100 that supports sidelink positioning reference unit management in accordance with aspects of the present disclosure. The operations of the method 2100 may be implemented and performed by a device or its components, such as a SL PRU 116 as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2102, the method may include receiving, from a network entity, a request for capability information regarding the apparatus acting as a sidelink positioning reference unit. The operations of 2102 may be performed in accordance with examples as described herein. In some implementations, aspects of the operations of 2102 may be performed by a device as described with reference to FIG. 1.

At 2104, the method may include transmitting, to the network entity in response to the request, capability information regarding the apparatus acting as a sidelink positioning reference unit. The operations of 2104 may be performed in accordance with examples as described herein. In some implementations, aspects of the operations of 2104 may be performed by a device as described with reference to FIG. 1.

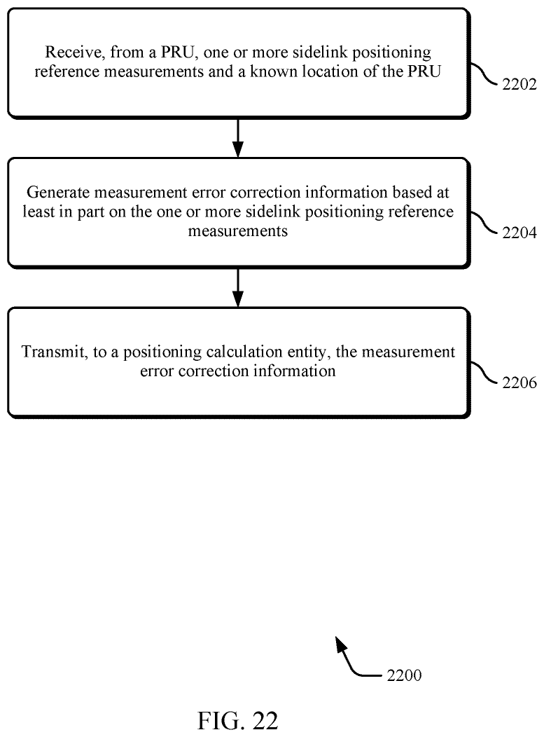

FIG. 22 illustrates a flowchart of a method 2200 that supports sidelink positioning reference unit management in accordance with aspects of the present disclosure. The operations of the method 2200 may be implemented and performed by a device or its components, such as a configuration entity as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2202, the method may include receiving, from a PRU, one or more sidelink positioning reference measurements and a known location of the PRU. The operations of 2202 may be performed in accordance with examples as described herein. In some implementations, aspects of the operations of 2202 may be performed by a device as described with reference to FIG. 1.

At 2204, the method may include generating measurement error correction information based at least in part on the one or more sidelink positioning reference measurements. The operations of 2204 may be performed in accordance with examples as described herein. In some implementations, aspects of the operations of 2204 may be performed by a device as described with reference to FIG. 1.

At 2206, the method may include transmitting, to a positioning calculation entity, the measurement error correction information. The operations of 2206 may be performed in accordance with examples as described herein. In some implementations, aspects of the operations of 2206 may be performed by a device as described with reference to FIG. 1.

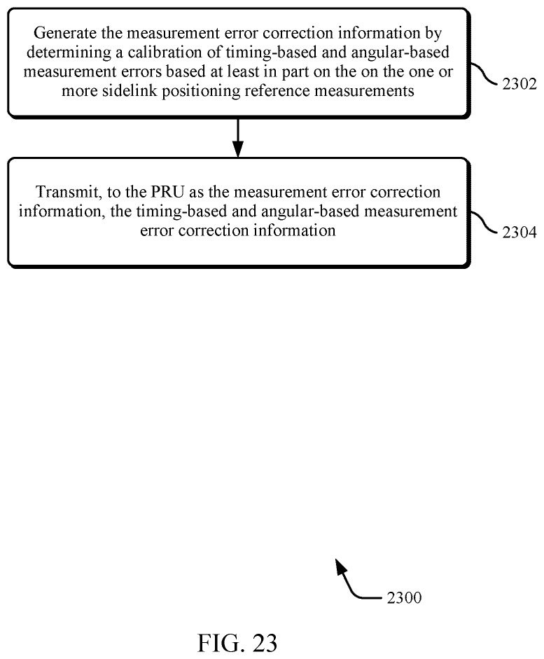

FIG. 23 illustrates a flowchart of a method 2300 that supports sidelink positioning reference unit management in accordance with aspects of the present disclosure. The operations of the method 2300 may be implemented and performed by a device or its components, such as a configuration entity as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2302, the method may include generating the measurement error correction information by determining a calibration of timing-based and angular-based measurement errors based at least in part on the on the one or more sidelink positioning reference measurements. The operations of 2302 may be performed in accordance with examples as described herein. In some implementations, aspects of the operations of 2302 may be performed by a device as described with reference to FIG. 1.

At 2304, the method may include transmitting, to the PRU as the measurement error correction information, the timing-based and angular-based measurement error correction information. The operations of 2304 may be performed in accordance with examples as described herein. In some implementations, aspects of the operations of 2304 may be performed by a device as described with reference to FIG. 1.

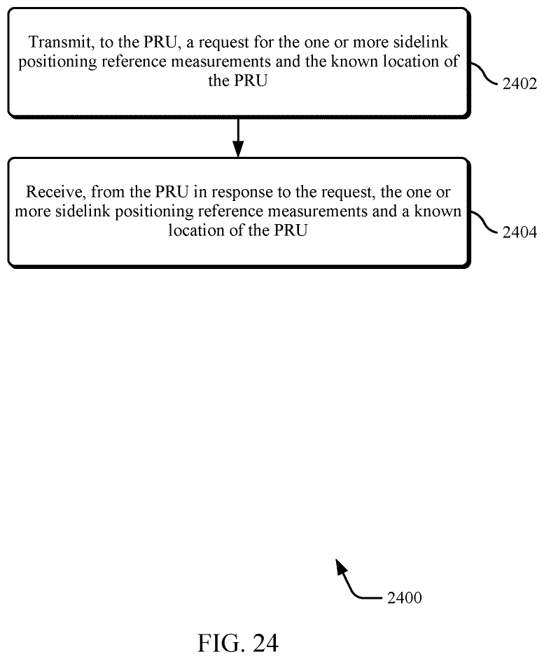

FIG. 24 illustrates a flowchart of a method 2400 that supports sidelink positioning reference unit management in accordance with aspects of the present disclosure. The operations of the method 2400 may be implemented and performed by a device or its components, such as a configuration entity as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2402, the method may include transmitting, to the PRU, a request for the one or more sidelink positioning reference measurements and the known location of the PRU. The operations of 2402 may be performed in accordance with examples as described herein. In some implementations, aspects of the operations of 2402 may be performed by a device as described with reference to FIG. 1.

At 2404, the method may include receiving, from the PRU in response to the request, the one or more sidelink positioning reference measurements and a known location of the PRU. The operations of 2404 may be performed in accordance with examples as described herein. In some implementations, aspects of the operations of 2404 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Similarly, a list of at least one of A; B; or C means A or B or C, or AB or AC or BC, or ABC (i.e., A and B and C). Similarly, a list of one or more of A; B; or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
receive, from a configuration entity, a measurement configuration to perform sidelink positioning reference measurements;
collect one or more sidelink positioning reference measurements; and
transmit, to the configuration entity, the one or more sidelink positioning reference measurements and a known location of the apparatus.

2. The apparatus of claim 1, wherein the one or more sidelink positioning reference measurements include at least one of a timing-based reference measurement or an angular-based reference measurement.

3. The apparatus of claim 1, wherein the one or more sidelink positioning reference measurements include at least one of a sidelink reference signal time difference (SL-RSTD) reference measurement, a sidelink (SL) user equipment (UE) receive transmit (Rx-Tx) time difference reference measurement, a SL time-of-flight (ToF) reference measurement, a time-of-arrival (ToA) reference measurement, a SL-angle-of-arrival measurement, a SL time difference of arrival (TDoA) reference measurement, a SL round trip time (RTT) reference measurement, or a SL angle of arrival (AoA) reference measurement.

4. The apparatus of claim 1, wherein the known location of the apparatus includes one or more of 2D or 3D latitude and longitude information, height or altitude information, a velocity estimate, an antenna and panel related location information and reference points, or an uncertainty value or a confidence interval associated with the known location.

5. The apparatus of claim 1, wherein the configuration entity comprises a user equipment (UE) or a network entity, and wherein the at least one processor is further configured to cause the apparatus to:
receive, from the UE or the network entity, a request for the one or more sidelink positioning reference measurements and the known location of the apparatus; and
transmit, to the UE or the network entity in response to the request, the one or more sidelink positioning reference measurements and a known location of the apparatus.

6. (canceled)

7. The apparatus of claim 1, wherein the apparatus comprises a user equipment (UE), and wherein the at least one processor is further configured to cause the apparatus to operate in at least one of a UE-based UE-configured positioning mode, a UE-based network-configured positioning mode, a UE-assisted UE-configured positioning mode, or a UE-assisted network-configured positioning mode.

8. The apparatus of claim 1, wherein the at least one processor is further configured to cause the apparatus to:
collect one or more new radio (NR) Uu interface positioning reference measurements; and
transmit, to a base station, the one or more NR Uu positioning reference measurements and the known location of the apparatus.

9. The apparatus of claim 1, wherein the apparatus includes an apparatus identifier (ID) that is at least one of a layer one ID (L1-ID) derived from a layer two ID (L2-ID), a self-generated ID, or an application ID generated by a sidelink positioning application of the apparatus, and wherein the at least one processor is further configured to cause the apparatus to:
transmit, to the configuration entity, the apparatus ID with the one or more sidelink positioning reference measurements and the known location of the apparatus.

10. The apparatus of claim 1, wherein the at least one processor is further configured to cause the apparatus to:
receive, from a user equipment (UE) or a network entity, a request for capability information regarding the apparatus acting as a sidelink positioning reference unit; and
transmit, to the UE or the network entity in response to the request, capability information regarding the apparatus acting as a sidelink positioning reference unit.

11. (canceled)

12. The apparatus of claim 1, wherein the at least one processor is further configured to cause the apparatus to:
dynamically update a known location and antenna orientation information of the apparatus, wherein the updated known location and antenna orientation information is based at least in part on delta locations compared to one or more previously reported locations.

13. An apparatus, comprising:
at least one memory; and
at least one processor coupled with the at least one memory and configured to cause the apparatus to:
receive, from a positioning reference unit (PRU), one or more sidelink positioning reference measurements and a known location of the PRU;
generate measurement error correction information based at least in part on the one or more sidelink positioning reference measurements; and
transmit, to a positioning calculation entity, the measurement error correction information.

14. The apparatus of claim 13, wherein the at least one processor is further configured to cause the apparatus to:
generate the measurement error correction information by determining a calibration of timing-based and angular-based measurement errors based at least in part on the on the one or more sidelink positioning reference measurements; and
transmit, to the PRU as the measurement error correction information, the timing-based and angular-based measurement error correction information.

15. The apparatus of claim 13, wherein the measurement error correction information includes at least one of pseudo-range errors, synchronization timing errors, reference signal time difference (RSTD) reference measurements, angle of arrival (AOA) calibration errors, or time validity duration of the measurement error correction information.

16. The apparatus of claim 13, wherein the at least one processor is further configured to cause the apparatus to:
transmit, to the PRU, a measurement configuration for the PRU to perform sidelink positioning reference measurements using the one or more sidelink positioning reference measurements, and
receive, in response to the measurement configuration, the one or more sidelink positioning reference measurements and the known location of the PRU.

17. The apparatus of claim 13, wherein the apparatus comprises a user equipment (UE) or network entity, and wherein the at least one processor is further configured to cause the apparatus to:
transmit, to the PRU, a request for the one or more sidelink positioning reference measurements and the known location of the PRU; and
receive, from the PRU in response to the request, the one or more sidelink positioning reference measurements and a known location of the PRU.

18. (canceled)

19. The apparatus of claim 13, wherein the at least one processor is further configured to cause the apparatus to:
transmit, to the PRU, a request for capability information regarding the PRU acting as a sidelink positioning reference unit; and
receive, from the PRU in response to the request, capability information regarding the PRU acting as a sidelink positioning reference unit.

20. A method performed by a positioning reference unit (PRU), the method comprising:
receiving, from a configuration entity, a measurement configuration to perform sidelink positioning reference measurements;
collecting one or more sidelink positioning reference measurements; and
transmitting, to the configuration entity, the one or more sidelink positioning reference measurements and a known location of the PRU.

21. A processor for wireless communication, comprising:
at least one controller coupled with at least one memory and configured to cause the processor to:
receive, from a configuration entity, a measurement configuration to perform sidelink positioning reference measurements;
collect one or more sidelink positioning reference measurements; and
transmit, to the configuration entity, the one or more sidelink positioning reference measurements and a known location of the processor.

22. The processor of claim 21, wherein the one or more sidelink positioning reference measurements include at least one of a timing-based reference measurement or an angular-based reference measurement.

23. The processor of claim 21, wherein the known location of the processor includes one or more of 2D or 3D latitude and longitude information, height or altitude information, a velocity estimate, an antenna and panel related location information and reference points, or an uncertainty value or a confidence interval associated with the known location.
